(19) United States
(12) Patent Application Publication
(10) Pub. No.: US 2019/0315345 A1
(43) Pub. Date: Oct. 17, 2019

(54) BLIND SPOT POTENTIAL-HAZARD AVOIDANCE SYSTEM

(71) Applicants: David E. Newman, Poway, CA (US); R. Kemp Massengill, Palos Verdes, CA (US)

(72) Inventors: David E. Newman, Poway, CA (US); R. Kemp Massengill, Palos Verdes, CA (US)

(21) Appl. No.: 16/148,390

(22) Filed: Oct. 1, 2018

Related U.S. Application Data
(60) Provisional application No. 62/762,013, filed on Apr. 16, 2018.
(60) Provisional application No. 62/762,503, filed on May 7, 2018.
(60) Provisional application No. 62/718,729, filed on Aug. 14, 2018.

(51) Int. Cl. B60W 30/09; B60W 50/14; B60W 50/12

(52) U.S. Cl. CPC B60W 30/09; B60W 50/14; B60W 50/12; B60W 2550/30; B60W 2540/10; B60W 2540/12; B60W 2540/18; B60W 2050/143

(57) ABSTRACT

A system to prevent vehicle collisions by resolving potential hazards before they become imminent collisions. An automatic potential-hazard avoidance system can monitor traffic proximate to a subject vehicle, determine when a potential hazard situation is present, and select an appropriate responsive sequence of actions to avoid the potential hazard. Embodiments may provide a gradual, transparent, computer-controlled intervention to move the vehicle away from potential hazard regions.

### PRIORITY CLAIMS AND RELATED APPLICATIONS

This application claims the benefit of a U.S. Provisional Patent Application No. 62/762,013 entitled “Blind Spot Collision Avoidance” and filed on Apr. 16, 2018, and U.S. Provisional Patent Application No. 62/762,503 entitled “Blind Spot Collision Avoidance” and filed on May 7, 2018, and U.S. Provisional Patent Application No. 62/767,705 entitled “Blind Spot Collision Avoidance” and filed on May 14, 2018, and U.S. Provisional Patent Application No. 62/718,729 entitled “Blind Spot Potential-Hazard Avoidance System” and filed on Aug. 14, 2018. The entire disclosures of all the above-mentioned applications are incorporated by reference as part of the specification of this application.

### FIELD OF THE INVENTION

The present invention relates generally to traffic hazard avoidance. More particularly, the present invention is directed in one exemplary aspect to systems and methods for avoiding potential hazards pertaining to blind spots and related vehicle hazards.

### BACKGROUND

Many accidents are caused by a driver being unaware of another vehicle in a blind spot and subsequently changing lanes, thereby causing a potentially fatal crash. The National Highway Traffic Safety Administration reports that nearly 840,000 blind spot accidents are reported each year on US roads. These are only the reported accidents, and it is certainly a reasonable assumption that many others are not reported. In addition, untold numbers of collisions result from side-encroachment maneuvers even when the vehicles are not in their respective blind spots, and many more collisions involve tailgating and other front-rear collisions. Yet every one of them is preventable.

The prior art includes BSD (blind spot detection) systems that scan for other vehicles in a subject vehicle's blind spots. Such systems then inform the driver of the hazard, typically with luminous indicators mounted on the side mirrors or the dashboard display. Other systems include BSA (blind spot avoidance) systems, which attempt to avoid a hazard by automatically accelerating or braking or steering to avoid colliding with another vehicle in a blind spot, or when the subject vehicle is in another vehicle's blind spot. Additionally, the prior art includes vehicle proximity sensors designed to detect all vehicles anywhere around the subject vehicle. Such proximity sensors may display the surrounding traffic data to the driver such as a map-like view showing the traffic distribution in real-time. (As used herein, vehicle proximity sensors refer only to moving-vehicle detectors, and NOT to car alarms on stationary vehicles.)

Many prior-art collision-avoidance systems treat potential hazards in the same way as imminent collisions, by invoking an automatic intervention that literally takes control away from the driver. Other prior-art systems display so much unnecessary information that the driver may be distracted from the more important job of driving. The majority of prior-art systems, however, ignore potential hazards until they become imminent collisions, and only then take emergency action.

What is needed is a system that provides blind spot detection and avoidance, integrated with front and rear potential-hazard warning and avoidance. Preferably, such a system would provide the potential-hazard avoidance smoothly and automatically, and without burdening the driver with unwanted information, and without generating a sense that the vehicle was out of control during the automatic intervention. Preferably, the system would provide a controlled, proportionate intervention when needed to avoid a potentially hazardous relationship with other vehicles, appropriate to the traffic situation and avoiding sudden or excessive responses.

### SUMMARY

Disclosed herein is a system for recognizing and avoiding potentially hazardous situations in traffic (the “potential-hazard avoidance system”, or simply the “system”). Most traffic collisions are preceded by a period of time in which two vehicles remain in a relationship that is potentially hazardous but does not constitute an imminent collision or emergency. At some moment, one of the drivers takes an unexpected action which causes the potentially hazardous situation to suddenly becomes a real hazard that requires immediate and strong action to avoid a collision. An objective of the potential-hazard avoidance system is to recognize potentially hazardous situations as soon as they arise, and to apply an automatic intervention that reduces or avoids the potential hazard before it becomes an emergency. Another objective is to reduce vehicle collisions by reducing the amount of time that vehicles spend in a potentially hazardous relationship. Another objective is to perform the potentially-hazardous avoidance maneuver in a controlled, gradual manner that smoothly blends with other driving activities. Another objective is to coordinate with an emergency intervention system; specifically, the emergency intervention system always prevails over the potentially-hazardous avoidance system. The system disclosed herein saves lives by recognizing and avoiding the main causes of vehicle collisions while they are merely potential hazards, long before they become real emergencies.

In some embodiments, the potential-hazard avoidance system may comprise one or more sensors, a speed controller, and a processor, and non-transient computer-readable media, all mounted on a subject vehicle. The non-transient computer-readable media may contain a plurality of predetermined sequences of actions, each sequence comprising sequential periods of acceleration or deceleration or waiting. Each sequence of actions may include at least one period of acceleration and at least one period of deceleration. The one or more sensors may be configured to collect data on one or more other vehicles proximate to the subject vehicle. The processor may be configured to determine whether one or more of the other vehicles is in a predetermined threat zone proximate to the subject vehicle. The processor may be further configured to select, from the plurality of predetermined sequences of actions, a particular sequence selected to move the subject vehicle relative to the one or more other vehicles in the threat zone. The processor may be further configured to send control signals to a speed controller according to the selected sequence of actions, the speed controller being configured to adjust the speed of the subject vehicle according to the received control signals and thereby cause the subject vehicle to move relative to the one or more other vehicles which are in the threat zone. The processor may be further configured to determine, after the subject vehicle has executed the sequence of actions, whether the one or more other vehicles are still in the threat zone.

As used herein, the subject vehicle, the second vehicle, and the other mentioned vehicles may comprise an automobile, a truck, a bus, a motorcycle, or any other motorized conveyance that may travel on a roadway. The sensors may comprise internal sensors and external sensors. The internal sensors may comprise transducers configured to measure a parameter of the subject vehicle such as its speed or the state of its steering or whether the brakes are applied, for example. The external sensors may comprise devices to acquire data on other vehicles proximate to the subject vehicle, such as the speed or acceleration or direction of travel of the other vehicles. The external sensors may include proximity measuring devices and/or imaging devices and may determine whether the other vehicle's brake lights are on, and may determine further data about the other vehicles in real-time. The speed controllers may comprise linkages or transducers or other devices that control the subject vehicle's propulsion such as a throttle plate or an electronic power regulator for example. The processor may comprise a digital electronic computing device or a plurality of such devices, configured to analyze data from the sensors and to send control signals to the motion controllers.

In some embodiments, the potential-hazard avoidance system may be configured to cause the subject vehicle to accelerate or decelerate by regulating the propulsion only, and not to perform automatic steering or braking of the subject vehicle so long as the hazard remains merely potential. For actual emergency situations, the subject vehicle may include an automatic intervention system to avoid or mitigate imminent collisions wherein the emergency intervention system, unlike the potential-hazard avoidance system, can control all of the subject vehicle's motion controls including the brakes, steering, and throttle in an emergency. Also, the potential-hazard avoidance system may be limited in the intensity of intervention applied, whereas the emergency system may be capable of exerting as strong a response as the subject vehicle can physically produce. As a third difference, the potential-hazard avoidance system always subordinates to the emergency response system.

In some embodiments, the potential-hazard avoidance system may be configured to recognize potentially hazardous situations in traffic, and to escape from them by temporarily accelerating or decelerating the subject vehicle. As used herein, “accelerating” means increasing the speed of the subject vehicle by increasing the power, and “decelerating” means decreasing the speed by decreasing the power, but not by applying the brakes. “Braking” means applying the brakes. Speed changes may be specified as positive or negative accelerations, wherein decelerations comprise negative accelerations. Accelerations may also be specified in magnitude form in which the sign is ignored. The “initial speed” is the speed of the subject vehicle before an automatic intervention is implemented, and the “final speed” is its speed after the implementation has terminated. The system may be configured to restore the final speed of the subject vehicle to its initial speed after the intervention. The system may be further configured to restore the acceleration to zero at the end of the intervention. In a preferred embodiment, the accelerations and decelerations may be provided in a gradual way that minimizes the rate of change of acceleration (also called jerk or jolt), thereby avoiding a sense of loss of control in the subject vehicle driver and minimizing discomfort in the subject vehicle occupants. Such a gradual, low-acceleration, low-jolt intervention may be termed a “gradual” intervention or a “mild” mitigation of the potential hazard.

Drivers are typically very sensitive to any changes in their vehicle's behavior that the driver has not commanded. Any sudden change can be disconcerting even if the driver knows that the vehicle has an intervention system. Therefore, in some embodiments, the system may respond to non-emergency merely-potential hazards by applying a gradual intervention in which accelerations are applied incrementally. For example, the system may start with an imperceptible rate of change that is then ramped up, or increased in a smoothly controlled fashion, to a maximum value, and then held at that maximum level until the potential hazard has cleared, and then may smoothly and gradually withdraw the intervention by restoring the speed to the initial value. In addition, the processor may be configured to limit the speed change to no more than a small predetermined value relative to the initial speed, and/or to limit the acceleration level to no more than a maximum acceleration value, and/or to limit the amount of jolt of the subject vehicle. In addition, each such kinetic parameter may be limited to be no more than specific limits throughout the intervention. The limits may be predetermined and fixed, or adjustable by the driver, or adjustable in real-time by the processor according to traffic conditions. For example, to accomplish the potential-hazard avoidance in a predetermined amount of time such as 10 seconds, the maximum allowable speed change may be adjusted according to the size of the second vehicle.

In some embodiments, the potential-hazard avoidance system can provide look-ahead analysis to recognize potential hazards and can provide a controlled automatic intervention to resolve the potential hazard by sending control signals to the speed controller, thereby causing the subject vehicle to accelerate or decelerate, and thereby to move relative to the second vehicle until the two vehicles are no longer in a potentially hazardous relationship. For example, the system can resolve potential hazards in which the subject vehicle is in a second vehicle's blind spot, or in which the second vehicle is in the subject vehicle's blind spot, or a potential side encroachment by either vehicle, or a slow lead vehicle, or a tailgater behind the subject vehicle. Each of these potential hazards can become a sudden emergency if either driver makes a wrong move. Therefore, the potential-hazard avoidance system may be configured to perform a gradual intervention maneuver to cause the subject vehicle to move so as to separate the vehicles. The system can initiate the gradual intervention as soon as the potential hazard is detected, or it can provide a brief delay time before initiating the gradual intervention. The delay time may enable a more precise determination of the vehicles' trajectories, or it may give the subject vehicle driver an opportunity to attempt a mitigation manually.

In some embodiments, the system may include non-transient computer-readable media containing instructions for a method, such as a method to perform the potential-hazard avoidance maneuver or a method to analyze sensor data. The media may also contain standard sequences of actions that can be performed to avoid the potential hazard, wherein each action may comprise an acceleration or a deceleration or a waiting period for example. The sequence of actions may also include branches and/or threshold values and/or limit values and/or algorithms for calculating parameters, for example. The media may further include sets of selection criteria, wherein each sequence of actions is associated with one set of selection criteria respectively. Each selection criterion may comprise a logical condition, or an arithmetic formula, or an algorithmic interrogator related to the potential hazard, so that the processor can select which of the standard sequences is most suitable for resolving the potential hazard. Thus a particular sequence of actions may be selected, from among the standard sequences of actions, in which the associated selection criteria are consistent with the current potential hazard or in which the selection criteria best fit the current potential hazard.

In some embodiments, the processor may be configured to analyze traffic using a kinetic model by which the future trajectories of the subject vehicle and the other vehicles may be projected forward in time. In addition to reading standard sequences of actions from the media, the processor may also be configured to prepare one or more new sequences of actions according to the observed distribution of traffic. The processor may be further configured to select the best sequence to avoid the potential hazard by analyzing the motions of the various vehicles when the subject vehicle is accelerated and decelerated according to each of the sequences. The processor may also be configured to vary parameters in the new sequences and/or the standard sequences to further improve the outcome, such as adjusting an acceleration level or reducing a maximum speed change for example.

In some embodiments, the system may include, or be coordinated with, a cruise-control system configured to maintain the subject vehicle speed constant, for example at a speed set by the driver. In some embodiments, the system may include, or be coordinated with, a lane-keeping assistance system configured to keep the subject vehicle centered between the lane lines. In some embodiments, the system may include, or be coordinated with, a front-end collision-avoidance system configured to apply the brakes when necessary to avoid coming too close to a leading vehicle. In some embodiments, the system may include, or be coordinated with, an emergency collision-avoidance system configured to operate the brakes, steering, and throttle to their maximum limits in an emergency, thereby to avoid a collision when avoidable, and to minimize the harm of the collision when unavoidable.

In some embodiments, the system may be configured to determine when a traffic situation cannot be resolved by actions available to the potential-hazard avoidance system, that is, by accelerating and/or decelerating only within certain limits. For example, if a situation calls for accelerating beyond the predetermined acceleration limits of the gradual mitigation, or if it requires braking or a lane change maneuver, or any other action other than the limited accelerations and decelerations available for potential-hazard mitigation, then the situation may be deemed “unresolvable”; that is, not resolvable by gradual speed changes alone. The system may include indicator means configured to indicate the presence of an unavoidable hazard, thereby alerting the driver using, for example, a dashboard light. Additionally, in some embodiments, the processor may determine that a potential hazard is unresolvable if a second vehicle persistently remains in a potentially hazardous relationship despite repeated automatic mitigation attempts, and may then alert the driver to the problem.

In some embodiments, the potential-hazard avoidance system may activate an emergency collision-mitigation system if the potential-hazard avoidance system detects that a potential hazard has become an imminent collision. The emergency collision-avoidance system and the potential-hazard avoidance system may comprise a single system in which separate sequences of actions are provided according to the situation being an emergency or a merely potential hazard.

In some embodiments, the system may recognize when the subject vehicle is in a traffic jam comprising dense slow-moving traffic on all sides. In a traffic jam, it is not possible to avoid having many other vehicles in close proximity. Therefore the system may suspend the potential-hazard avoidance service until the traffic begins moving. The system may continue monitoring for imminent collisions during the time that the potential-hazard avoidance is not feasible, thereby activating an emergency response when necessary. The probability per unit time of a collision is highest in tight traffic due to the close proximity of vehicles.

Alternatively, and more preferably, the potential-hazard avoidance system may be configured to continue providing gradual interventions even in a traffic jam, as well as in regular traffic when a plurality of other vehicles is present in the threat zones around the subject vehicle. To do so, the processor may be configured to analyze the current traffic distribution and prepare a total threat value according to the amount of potential hazard presented by each of the other vehicles and may further analyze sequences of actions to determine which sequence would reduce the total threat value. The total threat value may comprise an average or sum of the potential hazard values associated with each of the vehicles in the threat zones, or the total threat value may represent the highest potential hazard value, or a mathematical combination of the various threat values of the other vehicles such as the square-root of the sum of the squares of the other vehicle threat values, or other formula. The processor may then implement the particular sequence that reduces or minimizes the total threat value, thereby reducing or resolving as many of the potential hazards as possible. The sequence may be selected to provide the most rapid reduction in the total threat value. The processor may then continue adjusting the gradual intervention continually, or periodically, according to the changing flow of traffic around the subject vehicle.

In some embodiments, the processor may be configured to identify an “escape route” comprising a space or region proximate to and contiguous to the subject vehicle, large enough for the subject vehicle to move into, and having no vehicles therein. The escape route could be in front or behind or on either side of the subject vehicle or at an angle for example. The processor may be configured to adjust the subject vehicle position to create such an escape route if none exists at a particular time. In an imminent collision emergency, the subject vehicle may use the escape route to avoid the collision.

In some embodiments, the system may include various operational modes and parameters, and the subject driver can select which of the various modes and parameters are employed, for example by setting a control. Preferably the option of setting parameters may be limited to a period before the engine is started, or at least before the transmission is engaged, to avoid presenting distractions to the driver when in motion.

Defensive driving is the lowest-cost, most-effective way to stay safe on the highway. Vehicles that are well spaced apart are highly unlikely to collide. Therefore, the first rule of defensive driving is to maintain as much separation between vehicles as possible, given the traffic conditions. The potential-hazard avoidance system is configured to do exactly that.

Embodiments of the potential-hazard avoidance system as disclosed herein can reduce traffic collisions by actively avoiding potentially hazardous situations, thereby preventing them from ever growing into real emergencies. In this way the potential-hazard avoidance system can prevent collisions long before they become imminent. By automating the best “defensive driving” practices, such as maintaining plenty of space between vehicles and avoiding other vehicles' blind spots, the system eliminates all of the most common potential hazards that lead to freeway accidents. Most traffic collisions result from potential hazards that are left too long unresolved. The systems and methods disclosed herein resolve them promptly and automatically.

### FIGURES

FIG. 1 is a schematic showing exemplary threat zones around a subject vehicle.

FIG. 2 is a schematic showing exemplary watch zones and threat zones around a subject vehicle.

FIG. 3 is a series of graphs showing an exemplary intervention according to the present disclosure to avoid a potential hazard.

FIG. 4 is a series of graphs showing a second exemplary intervention according to the present disclosure using gradual acceleration.

FIG. 5 is a flowchart showing steps of an exemplary method to perform a gradual intervention for various traffic conditions.

FIG. 6 is a flowchart showing steps of an exemplary embodiment of the inventive method for determining whether a potential hazard can be resolved using gradual acceleration and gradual deceleration steps.

FIG. 7 shows an exemplary flowchart of an embodiment of a method to respond to emergency conditions such as an imminent collision.

FIG. 8 is a series of graphs showing an exemplary intervention with a variable drift time.

FIG. 9 is an exemplary schematic showing how a vehicle could respond to a multi-vehicle hazard.

FIG. 10 is a schematic showing how an exemplary multiple-hazard situation may be handled in some embodiments.

### DETAILED DESCRIPTION

In the following description, reference is made to the accompanying drawings in which it is shown by way of illustration specific embodiments in which the invention can be practiced. It is to be understood that other embodiments can be used and changes can be made without departing from the scope of the embodiments of disclosed herein.

An embodiment of a potential-hazard avoidance system may comprise sensors, a speed controller, and a processor. The system may further include non-transient computer-readable media containing predetermined sequences of actions, and selection criteria associated with each sequence respectively. In some embodiments, the system may be configured to implement a gradual intervention responsive to a merely potential hazard, wherein the intervention may comprise no more than small amounts of acceleration and/or deceleration to escape the potential hazard. In a real emergency, on the other hand, the brakes and steering and all possible measures may be available as needed, with unrestricted intensity up to the maximum capabilities of the subject vehicle.

The sensors may comprise internal sensors, which may be configured to measure a parameter of the subject vehicle such as the velocity or the status of brakes or steering or other parameters of the subject vehicle, and external sensors which may be configured to detect a second vehicle proximate to the subject vehicle and to measure parameters of the second vehicle such as its distance or angle or position or speed relative to the subject vehicle. The external sensors may also determine the status of the second vehicle's brake lights or its physical size, among other parameters. The external sensors may also monitor lane markings and other environmental data.

In some embodiments, the processor may implement the selected sequence of actions by sending control signals sequentially to the speed controller of the subject vehicle. The speed controller may comprise the throttle of the subject vehicle, or whatever is used to adjust the drive power. The throttle may be the conventional accelerator pedal of the subject vehicle, or it may comprise an electronically controlled acceleration/deceleration means such as a carburetor throttle plate controller which bypasses the foot pedal. Or, if the vehicle is electrically powered, the accelerator may comprise the power regulator that controls the current or voltage applied to the electric motor.

In some embodiments, the processor may comprise digital electronics configured to read and execute a program comprising instructions stored on non-transient computer-readable media. The instructions when executed may cause the processor (or processors, if configured as multiple separate circuits) to perform a method. The method may comprise detecting vehicles, detecting potential hazards, and moving the subject vehicle to avoid the potential hazards. The media may also contain a plurality of standard or predetermined sequences of actions, wherein each action may comprise an acceleration or a deceleration or a waiting time. The media may also contain a plurality of sets of selection criteria, each set being associated with one of the sequences respectively. The selection criteria may comprise interrogators, such as whether the second vehicle is in a left or right-side threat zone, or whether the second vehicle is traveling faster or slower than the subject vehicle, and similar logical criteria. The selection criteria may also comprise algorithmic forms such as calculating differential velocities and/or probabilities of future events. The processor may respond to a potential threat by selecting a particular sequence of actions that is most appropriate for a potentially hazardous situation. The processor may select an appropriate sequence according to all of the associated selection criteria being satisfied, or the processor may select the most appropriate sequence according to a rating formula that quantitatively relates the selection criteria to the current potential hazard. The processor may then implement the selected sequence by sending control signals to the speed controller, the control signals being configured to cause the subject vehicle to move or to change speed according to the selected sequence. The selection criteria may assist the processor in selecting which of the predetermined sequences of actions to select. However, if no selection criteria are provided, or if the current potential hazard is incompatible with all of the sets of selection criteria, or for any other reason, the processor may be configured to generate sequences of actions de novo. The processor may be configured to select the particular sequence of actions for implementation by projecting the paths of the various vehicles forward in time, thereby determining whether each sequence could resolve the potential hazard or which sequence would best reduce the potential hazard.

In some embodiments, the processor may include feedback configured to keep the subject vehicle moving in such a way that the potential hazard is resolved or reduced. The feedback may comprise “response” type feedback or “tracking” type feedback or “sequence” type feedback for example. In response-type feedback, the processor may be configured to adjust the control signals in real-time to cause the subject vehicle to more closely follow the velocity or acceleration called for by each action of the sequence of actions. For example, if the sequence calls for accelerating at 1 kph/sec and the vehicle is actually accelerating at 1.1 kph/sec, the processor may reduce the throttle slightly, and thereby reduce the actual acceleration to more closely match the acceleration value specified in the sequence of actions. Alternatively, the processor may include tracking type feedback wherein the processor is configured to monitor the deviation of the subject vehicle's actual position relative to the calculated trajectory, and to adjust the throttle control signals to bring the subject vehicle more closely along the projected trajectory, even if that deviates from the specified acceleration. As a further and even more preferable alternative, the processor may be configured to apply sequence-type feedback wherein the processor can periodically review the traffic conditions during the intervention and can then recalculate or revise the remaining sequence steps to produce the mitigation desired.

In some embodiments, the processor may be configured to determine whether a potential hazard exists by analyzing data from the external sensors, thereby detecting the second vehicle, and may then determine whether the second vehicle is in the threat zone of the subject vehicle. In some embodiments, the threat zone is a predetermined region around the subject vehicle comprising side threat zones and front and back threat zones. The side threat zones may comprise regions where the second vehicle is in the subject vehicle's blind spot, plus regions where the subject vehicle is in the second vehicle's blind spot, plus a side-encroachment region where the second vehicle could collide with the subject vehicle if either vehicle suddenly changed lanes. The front and back threat zones may comprise regions fore and aft of the subject vehicle where a second vehicle would likely collide with the subject vehicle if whichever vehicle is leading would suddenly stop. The processor may select different sequences of actions according to which threat zone is occupied, and other factors.

In some embodiments, the side threat zones extend contiguously from a predetermined distance behind the subject vehicle to a second predetermined distance ahead of the subject vehicle. Such side-behind and side-ahead distances, which determine the boundaries of the side threat zones, may be fixed and predetermined, or they may be variable according to traffic parameters. For example, the side-ahead distance may be fixed at 4 meters or one vehicle-length or some other distance, or it may be variable depending on vehicle speed and environmental conditions such as rain. The side threat zones may encompass the subject vehicle's blind spot region, plus the side-encroachment threat region, plus the region where a second vehicle would have the subject vehicle in its blind spot. The side-ahead and side-behind boundaries of the side threat zones may be determined by the collision potential, or more specifically, whether the second vehicle would collide, or nearly collide, with the subject vehicle if either vehicle suddenly changed lanes. If the second vehicle is just ahead of the side threat zone and suddenly changes lanes in front of the subject vehicle, the second vehicle would miss the subject vehicle but would be too close for safety, at which time (if not sooner) the subject vehicle may recognize a potential hazard for front-end collision and may invoke a gradual deceleration to allow more space to open up between it and the second vehicle. The close approach of the second vehicle may also trigger an emergency braking response by the driver or by an emergency intervention system if present.

In some embodiments, the system may include “watch” zones that extend beyond the threat zones. Traffic in the watch zones is generally not a potential threat but may affect decisions regarding the preferred choice for a potential-hazard avoidance strategy. For example, a second vehicle in the left side threat zone may trigger a potential-hazard avoidance move, which may be to either accelerate or decelerate if both the front and back threat zones are clear. But if a third vehicle is in the center back watch zone, then the best sequence may be to accelerate forward and thereby put more distance between the subject vehicle and the third vehicle, as well as avoiding the second vehicle in the side threat zone.

In some embodiments, the processor may be configured to select a particular sequence of actions and to implement the sequence by sending control signals to the speed controller of the subject vehicle. Each action in the sequence of actions may cause the subject vehicle to accelerate or decelerate for specified amounts of time at specified levels of intensity, or the action may be simply waiting for a particular time. The action may also be conditional or bounded, such as continuing to accelerate until a particular condition has been met. In some embodiments, the processor may adjust one or more parameters of the particular sequence, such as adjusting the amount of time that an acceleration or deceleration is performed, depending on the size of the second vehicle for example. The particular sequence may contain branches or options, such as continuing to accelerate until the second vehicle is out of the blind spot, or choosing not to accelerate if a third vehicle is directly in front.

In some embodiments, the processor may be configured to select one of the sequences of actions according to a set of predetermined selection criteria. For example, the computer-readable media that contain the sequences may also contain sets of selection criteria, one set per sequence. Alternatively, the sequences and their associated selection criteria may be on separate media. In a potentially hazardous situation, the processor may be configured to select a suitable sequence of actions, for example the first sequence of actions in which all of the associated selection criteria are satisfied. Alternatively, the processor may select a sequence of actions based on performance metrics, such as the particular sequence that provides the most rapid escape from the potential hazard situation, or the particular sequence that provides the greatest immediate rate of reduction in the potential hazard, or the particular sequence with the lowest peak acceleration, or the particular sequence with the lowest jolt. In addition, the processor may be configured to adapt the selection criteria and/or the selected sequence according to each situation, such as accelerating to resolve the hazard more quickly in fog or at night or on twisting roadways for example.

As a further example, the processor may detect a potential threat comprising a second vehicle in an adjacent lane and somewhat ahead of the subject vehicle. Such an arrangement represents a potential hazard because the subject vehicle may be in the second vehicle's blind spot, in which case one of the prepared sequences may include decelerating the subject vehicle until the second vehicle exits the side threat zone (or, more precisely, the subject vehicle decelerates until its side threat zone no longer includes the second vehicle). However, that response is appropriate only if the back-threat zone is clear. If the back-threat zone is occupied by another vehicle and the front threat zone is clear, then the preferred sequence may be to accelerate instead of decelerate. Thus, the selection criteria may include determining whether the second vehicle is ahead or behind the subject vehicle in the adjacent lane, and whether the back threat zone is clear. As a further example, if a second vehicle is in a side threat zone and is traveling slightly faster than the subject vehicle, but not so fast that it would exit the threat zone in a short enough time, then the system may gradually decelerate the subject vehicle to let the second vehicle pass forward, even if the second vehicle is initially behind the subject vehicle in the adjacent lane. Likewise, if the second vehicle is ahead but traveling slightly slower, then the subject vehicle may speed up. Thus the selection criteria can determine the logic for selecting the appropriate sequence of actions. In each case, the action may be continued for a predetermined amount of time, or it may be continued until the second vehicle is no longer in the side threat zone.

In another embodiment, no predetermined sequences of actions are provided, or alternatively none of the sets of selection criteria are consistent with a particular situation. In such cases, the processor may be configured to create new sequences of actions based on the particular traffic distribution. For example, the processor may use a kinetic model of the traffic to prepare a suitable response to any potential hazard. To do so, the processor may be configured to carry out a method that includes analyzing the external sensor data, detecting a second vehicle in one of the threat zones, calculating future positions of the second vehicle relative to the subject vehicle while the subject vehicle is accelerated or decelerated according to a sequence of actions, varying parameters of the sequence of actions to determine if any of the sequences of actions would resolve the potential hazard, and then implementing the selected sequence of actions. Multiple such sequences may be compared, and a preferred one selected, by projecting the various vehicle trajectories forward in time.

In some embodiments, the sequence of actions may be configured to limit the amount of acceleration and deceleration to no more than a predetermined maximum value. For example, the amount of acceleration and deceleration may be limited to sufficiently small values that the driver of the subject vehicle would not experience a feeling of loss of control. However, the range of acceleration values should not be so limited that the escape from the potentially hazardous situation takes more than a short time such as 10 seconds. For example, the permitted range of acceleration may be ±0.2 kph/sec or ±0.5 kph/sec or ±1 kph/sec, where the lower range provides a soft response, the higher range provides a faster escape, and the middle range represents a compromise.

In some embodiments, the sequence of actions may be configured to limit the maximum change in speed during the implementation, relative to the initial speed, to no more than a predetermined maximum value. Such limiting of the maximum speed change may provide a smoother and more gradual exit from the potentially hazardous situation. More specifically, the maximum allowable change in speed of the subject vehicle, relative to its initial speed before the intervention, may be limited to a predetermined maximum change in speed, or it may be limited to a predetermined fraction of the initial speed, or other limitation. For example, the maximum magnitude of the change in speed may be limited to a fixed value such as 1 kph or 2 kph or 4 kph. Alternatively, the maximum change in speed may be limited to a fraction of the initial speed, such as 1% or 3% or 6% of the initial speed of the subject vehicle, thereby adapting the permissible range of speeds to the current traffic conditions.

In some embodiments, the sequence of actions may be configured to limit the rate of change of acceleration, or jolt, to no more than a predetermined maximum value so as to avoid triggering a fear reaction in the subject vehicle driver or passengers. The gradual intervention may be configured to be so smooth and gradual that the driver and passengers may not notice the intervention unless they specifically try to detect it. For example, the maximum magnitude of the instantaneous jolt may be limited to a predetermined value, which may be 0.05 kph/sec² or 0.1 kph/sec² or 0.5 kph/sec² during the intervention.

In some embodiments, the sequences of actions, whether read from the media or newly generated when needed, may be configured to restore the speed of the subject vehicle at the end of the intervention back to the speed it had at the beginning of the intervention. To do so, the sequence must include at least one acceleration period and at least one deceleration period. The sequence of actions may be configured to equate or balance the periods of acceleration and deceleration, thereby setting the final speed equal to the initial speed of the subject vehicle. Such a sequence of actions causes the subject vehicle to temporarily speed up or slow down, then optionally reside at the new speed for a period of time, and then return to the initial speed. Due to the temporary speed change, the subject vehicle will have moved forward or backward relative to the second vehicle at the end of the maneuver. With proper adjustment of the magnitude and duration of the acceleration and deceleration periods, the subject vehicle will have moved sufficiently that the second vehicle is no longer in the subject vehicle's threat zones. In addition, the sequence of actions may be configured to set the acceleration of the subject vehicle to zero at the completion of the sequence. Alternatively, the sequence of actions may be configured to restore the acceleration at the end of the intervention back to whatever value of acceleration was present when the intervention was started. Since the driver apparently intended to accelerate or decelerate, the system may be configured to comply. As a further alternative, the sequence may be configured to check if the initial acceleration is greater than a predetermined limit, and if it is, then to take no action since whatever the driver is trying to do will likely affect the potential hazard relationship. In that case, the potential-hazard avoidance system may be configured to provide the potential hazard avoidance service only when the subject driver is not demanding acceleration or deceleration of the subject vehicle above the predetermined value, and to take no action when the subject vehicle is accelerating or deceleration at greater than the predetermined limit. For example, the system may be configured to withhold the gradual intervention whenever the subject vehicle is already accelerating or decelerating greater than a predetermined value such as ±0.01 kph/sec.

In some embodiments, the processor may be configured to perform the automatic intervention very gradually, so as to avoid distracting or needlessly alarming the subject vehicle driver, since such distractions may elicit resistance or unpredictable behavior. Such a gradual intervention may be configured to resolve the potential hazard in a short, predetermined period of time termed the “performance” time. As a non-limiting example, the performance time may be 5 seconds or 10 seconds for most situations, although the performance time may be extended to a higher value, such as 20-30 seconds when the second vehicle is very long, such as a bus or truck.

In some embodiments, the gradual intervention may involve only increases and deceases in the throttle setting, and not involve the brakes or steering. Such a gradual intervention may gently accelerate or decelerate the subject vehicle without disturbing the driver or passengers. In contrast, automatic application of the brakes and/or steering may be reserved for imminent collision situations, wherein a stronger automatic intervention may be life-saving. In normal traffic with normal merely-potential hazard situations, a gentle and gradual acceleration or deceleration may be sufficient to resolve the potential hazard relationship. For example, a blind spot hazard usually can be resolved by gradual velocity changes that the subject vehicle driver does not notice, or perhaps may barely notice, but is not be disturbed by it. Normal driving typically involves many continuous small speed changes due to wind and terrain and back-wash from passing vehicles and many other transient causes. Thus, the speed changes produced during a gradual intervention may be of the same magnitude as the normal variations. Preferably, for safety, the system may indicate to the subject vehicle driver when a potential hazard exists, or when a gradual intervention is in progress, using for example a lamp in a dashboard display. In other systems, the gradual intervention may be applied without such indication, for example to reduce distractions. The system may be configured to allow the driver to select whether such intervention indications are provided, as well as other alerts and messages related to the potential-hazard avoidance system.

In some embodiments, the processor may be configured to evaluate the sensor data, detect a second vehicle, and determine whether the second vehicle represents a potential hazard or an immediate threat. For example, a second vehicle traveling in the subject vehicle's blind spot comprises a merely potential hazard as long as the subject vehicle's steering is directed straight forward but may be elevated to an immediate threat if either vehicle starts to change lanes. The processor may be configured to implement different mitigation sequences for potential hazards and for immediate threats. For example, the processor may be configured to implement a gradual intervention for a potential hazard in which both vehicles remain traveling straight and steady, and an immediate emergency intervention if the vehicles appear to be on a collision course.

In some embodiments, the processor may be configured to determine that a potential hazard has become an imminent collision or other emergency, and then activate an emergency intervention system. For example, if there is a second vehicle in one of the side threat zones and the subject driver turns on the turn signal toward the occupied threat zone, the system may activate the emergency response system, or alternatively may switch to an emergency operating mode. As another example, if a side threat zone is occupied and the subject vehicle approaches that lane, such as coming within a predetermined distance of the lane line or other lane marker while continuing to move in that direction, then the processor may determine that an emergency has arisen. The predetermined distance may be in the range of 0.1 to 1.0 meters, such as 0.3 meters in a particular embodiment. Different alert levels may be activated depending on the distance, such as a mild automatic intervention if the distance is less than 0.5 meters, an emergency intervention involving steering away if the distance is less than 0.3 meters, and a higher emergency intervention involving steering and braking if the distance is less than 0.1 meters The system may detect the imminent collision and activate the emergency intervention system (if present on the subject vehicle), or the emergency intervention system may detect the imminent collision first and may then deactivate the potential-hazard avoidance system. If the subject vehicle does not have an emergency intervention system, then the potential-hazard avoidance system may be configured to alert the driver, or to minimize the imminent collision by implementing a potential-hazard avoidance maneuver, or to avoid the imminent collision entirely by applying the brakes, or by steering toward the opposite side, or by activating a single-wheel brake on the opposite-side rear wheel so as to veer away from the second vehicle for example. Thus, in an emergency situation, when no emergency intervention system is available, the potential-hazard avoidance system may be configured to take forceful actions that are not permitted for merely potential hazards, and thereby to prevent a collision.

As yet another example, the processor may determine that a potential hazard has become an emergency when a second vehicle enters the front or back threat zone while traveling at a speed sufficiently different from the subject vehicle that a collision may occur in a short time such as a few seconds. The threshold to declare an emergency based on the speed differential may be different for a front-encroachment and a back-encroachment since a tailgater presumably already knows that he is coming up to the subject vehicle, but a slow leading vehicle often is unaware of the imminent collision from behind. As an example, a second vehicle in the front threat zone and traveling at least a predetermined speed, such as 20 kph, slower than the subject vehicle may constitute an emergency, while a second vehicle in the back-threat zone may become an emergency if the tailgater is traveling at least another predetermined speed, such as 40 kph, faster than the subject vehicle. As a further alternative, the threshold for declaring an emergency may depend on the distance between vehicles as well as the speed differential. For example, a threshold based on time-to-collision may trigger the emergency response. In an exemplary embodiment, the processor may be configured to initiate the potential-hazard avoidance mitigation if the time-to-collision is less than a first predetermined time such as 10 seconds, and to initiate an emergency intervention if the time-to-collision is less than a second predetermined time such as 1 second.

In some embodiments, the processor may be configured to initiate a gradual intervention when the second vehicle enters the subject vehicle's blind spot. The processor may then select a gradual intervention sequence comprising gradually accelerating or decelerating until the second vehicle exits the threat zone, at which time the gradual intervention may be terminated or, more preferably, ramped down gradually. The termination ramp-down, comprising for example a gradual deceleration, may be sufficiently gradual that the subject vehicle driver remains undistracted.

In some embodiments, the potential-hazard avoidance system may be configured to wait for a predetermined delay time after detecting a potential hazard, and only after that delay time the processor then begins implementing a responsive gradual mitigation. For example, if a second vehicle enters the subject vehicle's blind spot, the processor may detect that entry, and may mark the time and select an appropriate sequence of actions but does not begin implementation. Then, after the predetermined delay time, the processor may again check whether the potential hazard is still present, and if so, the processor may then begin implementing the selected sequence of actions, such as gradually accelerating or decelerating. Alternatively, the processor may be configured to wait until the time delay expires, and then determine whether the second vehicle is still in the threat zone, and then select the sequence of actions according to the associated selection criteria, and then immediately begin implementing it. An advantage of waiting until after the delay time to select the best mitigation sequence may allow the processor to account for any changes that occur during the delay time.

As a third example, the processor may be configured to detect the intrusion, wait for the predetermined initial delay time, and then calculate whether the second vehicle will exit the threat zone within a second time period (which may be the same as the initial delay time or a different time limit), and only then begin implementing the gradual mitigation if the second vehicle is not expected to leave within the predetermined time limit. The initial delay time is preferably configured to be long enough that the processor can determine whether the potential hazard will self-resolve and thereby avoid implementing unnecessary interventions, however the initial delay time is preferably short enough that the potentially hazardous situation is not allowed to persist for long. Typically, the initial delay time is in the range of 2 to 10 seconds, with 4 seconds being most preferred. If after the initial delay time, the second vehicle is still in the threat zone and is calculated to remain in the threat zone for an additional predetermined exit time limit, such as 6-8 additional seconds, then the gradual mitigation may be implemented. In addition, the processor may be configured to continually monitor the relative motion of the two vehicles during the implementation, and to continually recalculate the exit time (that is, the calculated time remaining until the second vehicle is expected to exit the threat zone), and may terminate the intervention if the second vehicle begins moving in a way that will resolve the potential hazard more quickly than the sequence being implemented. As a further alternative, the processor may be configured to adjust the initial delay time and/or the exit time limit according to current traffic conditions, or to the subject vehicle's speed, or other conditions. In some embodiments, the subject vehicle driver can adjust the initial delay time, for example using an adjustment control, and can also adjust the exit time limit and other intervention parameters to suit the driver's style. For example, some drivers may want a potential-hazard intervention to begin as soon as the potential hazard is detected, while others would prefer to wait longer and see if the hazard clears itself.

In some embodiments, the processor may be configured to determine the relative velocity between the subject vehicle and the second vehicle, and thereby determine whether a potentially hazardous situation will likely persist or will spontaneously clear in due course. The processor may be configured to calculate a dwell time, equal to the amount of time that the second vehicle is expected to remain in the threat zone based on its relative velocity and the physical length of the threat zone. Alternatively, the processor may calculate an exit time at which the second vehicle is expected to exit from the threat zone. If the calculated exit time is greater than a predetermined time limit, the processor may then select an appropriate sequence of actions and calculate a second exit time according to the sequence of actions (that is, with the subject vehicle being accelerated and decelerated according to the sequence of actions). If the second exit time is less than the time limit, then the processor may proceed to implement the sequence of actions by sending the corresponding control signals to the speed controller. Alternatively, the processor may vary one or more parameters in the sequence of actions, such as the duration or magnitude of an acceleration, in order to improve the mitigation, or reducing the exit time further, or reducing the peak jolt.

If a second vehicle enters the subject vehicle's blind spot but is traveling slightly faster or slower than the subject vehicle, the processor can project the relative positions in future time, and thereby determine that the potentially hazardous condition is likely to resolve itself quickly because the second vehicle will likely pass out of the blind spot in a time short compared to the preset delay time or some other time limit. However, if the second vehicle enters the blind spot and then changes speed to match that of the subject vehicle, the processor may determine that the second vehicle will take too long to pass by and may then begin the delay time clock in preparation for the appropriate gradual intervention. As another example, if the speed difference between the two vehicles is greater than some threshold speed difference, the processor may determine that the situation does not require an intervention because the second vehicle will soon pass through the threat zone and exit. The threshold speed difference, which is sufficient to inhibit the intervention, is preferably high enough that the second vehicle is not allowed to linger in the threat zone indefinitely but is not so high that unnecessary interventions are frequently invoked. For example, the threshold speed difference for determining whether an intervention is needed, may be in the range of 0.5 to 2 kph, or it may be set equal to the maximum allowable intervention speed, or it may be adjusted according to traffic conditions.

In some embodiments, the processor may implement a gradual intervention responsive to a second vehicle in one of the threat zones, and may then terminate the intervention as soon as the second vehicle exits the threat zone. Alternatively, the processor may be configured to wait for a post-hazard delay time, after the potential hazard has cleared, before terminating or ramping down the intervention. The processor may be configured to check whether the potential hazard has re-occurred during the post-hazard delay time, thereby avoiding premature termination of the intervention. Thus, the post-hazard delay time ensures that the situation is really resolved before the intervention is terminated.

In some embodiments, the system may be configured to terminate the implementation if the potential hazard changes so as to become unresolvable. For example, the intervention may be terminated in event of an uncooperative second vehicle driver. The unresolvability may be discovered during an implementation by re-checking all of the sets of selection criteria and finding that none of them is consistent with the changed conditions. In that case the system may terminate the gradual intervention and may inform the subject vehicle driver of the problem. As another example, the system may determine during a gradual intervention that a collision has become imminent, or that some other emergency has arisen. In that case, the system may activate an alarm to warn the driver of the emergency, and/or it may activate the emergency collision-avoidance system if present, and/or may also terminate the gradual intervention to avoid interfering with driver actions. In some emergencies, on the other hand, the current hazard-avoidance actions may be beneficial and may be continued, thereby possibly delaying or softening the imminent collision. As a further possibility, if an emergency response system is present and detects the imminent collision before the potential-hazard avoidance system detects it, then the emergency intervention system may be configured to entirely dominate the subsequent action, and the potential-hazard avoidance system may be configured to release all control to the emergency system. Even more preferably, a single integrated system may be configured to apply a gradual mitigation to potential hazard situations and an emergency response to an imminent collision, all within the same system but implementing different sequences according to the severity of the hazard.

In some embodiments, terminating the intervention may include restoring the subject vehicle to its original speed, and preferably doing so gradually rather than suddenly. The terminating may also include restoring the acceleration and deceleration to zero after adjusting the final speed to equal the initial speed of the subject vehicle. A particular sequence of actions, which may be termed the “termination sequence”, may include gradually restoring the speed to the initial speed and restoring the acceleration and deceleration to zero. The processor may be configured to implement the termination sequence after the second vehicle exits the threat zone, or after the post-hazard delay time, or at any other time that the intervention is to be terminated. By providing a specific termination sequence, the system can ensure that the termination is gradual. The termination sequence may include actions that are opposite to the actions applied at the beginning of the intervention. For example, a mitigation comprising acceleration to escape a second vehicle may be followed by a termination sequence that includes a deceleration period to restore the speed of the subject vehicle to its initial speed. In general, any sequence of actions that restores the speed of the subject vehicle at the end of the intervention back to the initial speed, must include at least one period of acceleration and one period of deceleration.

In another embodiment, the processor may be configured to calculate the speed and acceleration of the subject vehicle and of the second vehicle. The processor may acquire data from internal sensors on the subject vehicle and may also receive imaging or range data from the external sensors. The processor may then calculate the projected trajectories of the vehicles assuming no intervention and may thereby determine how long the second vehicle is likely to remain in the side threat zone. That time may be termed the calculated or projected “dwell time” of the second vehicle. If the projected dwell time is less than a predetermined limit, then the processor may be configured to do nothing, and may simply wait for the second vehicle to pass by. But if the projected dwell time is greater than that limit, the processor may then calculate one or more sequences of actions, comprising accelerations and decelerations to modify the trajectory of the subject vehicle in various ways. The processor may be configured to compare a few or a large number of candidate sequences of actions and may then select the one sequence of actions that best resolves the potential hazard, for example making the selection based on performance metrics or predetermined selection criteria.

In some embodiments, the system may be operable for freeway traffic wherein multiple vehicles travel in substantially the same direction in multiple parallel lanes, as well as for two-lane roads with bidirectional traffic in two antiparallel lanes. The system may be configured to determine, from electronic maps or GPS coordinates or observation of the other vehicles or observation of the lane markings for example, whether one-way or two-way traffic is present. For example, the processor may be configured to determine when the subject vehicle is on a two-lane road with bidirectional traffic, by detecting that there is no lane to the right (that is, the subject vehicle is in the rightmost lane), and detecting at least one vehicle in the lane immediately to the left of the subject vehicle traveling in the opposite direction. When the subject vehicle is on a two-lane road, the left and right-side threat zones may be deactivated, however the front and back threat zones may still be monitored for potential front-back collision hazards. In a similar fashion, to detect a multilane highway, the processor may be configured to detect lanes to the left and right side of the subject vehicle, according to lane markers for example, and may detect traffic going in the same direction as the subject vehicle in those adjacent lanes and may thereby determine that the roadway is a multilane highway. When the processor discovers that the roadway is a multilane highway, the processor may automatically resume monitoring the left and right-side threat zones for potential hazards.

In some embodiments, the processor can determine whether an intervention is progressing as planned, and it may adjust the selected sequence of actions according to further, updated calculations. For example, the processor may detect a second vehicle in the subject vehicle's blind spot and may implement a gradual acceleration to draw forward and clear the potential hazard, but then the second vehicle may change its speed so as to remain in the subject vehicle's blind spot despite the acceleration maneuver. The system may then respond by: (a) raising the intervention velocity to a higher predetermined value, such as raising the velocity from 1 kph to 2 kph, and continuing forward for a time to see if the second vehicle again thwarts the intent, or (b) slowing down by either the lower or upper velocity limit, to allow the second vehicle to pass by, or (c) terminating the intervention until the second vehicle stops changing its speed, among many other possible responses. In addition, if the attempted potential hazard mitigation fails twice (or some other number that the driver may select), then the processor may illuminate an indicator that informs the subject driver that a potential hazard remains in the subject vehicle's blind spot. The subject driver can then decide what to do, such as nothing, or changing lanes in the other direction, or whatever the driver prefers. Thus the automatic system may be configured to do everything it can safely do, and to request the driver's attention only when it runs out of options.

In some embodiments, the system may alert the driver of the subject vehicle when the system determines that the potential hazard cannot be resolved by accelerating or decelerating the subject vehicle. In that case the potential hazard may be termed “unresolvable”, meaning not resolvable by the potential-hazard avoidance system using only gradual and limited accelerations and decelerations. For example, the processor may be configured to select a sequence of actions based on their associated selection criteria, but in a particular situation none of the sets of selection criteria is consistent with the potential hazard at hand. In that case the processor may declare the situation unresolvable by the potential-hazard avoidance system, and then may alert the driver of this finding. As a second example, the processor may be configured to create a sequence of actions using a kinetic model, or by other analysis procedure, and then may discover that none of the calculated sequences of actions would resolve the potential hazard. In that case the processor may declare the situation unresolvable and may alert the driver to that fact.

In some embodiments, a third vehicle may enter a threat zone while a sequence of actions is already being implemented to escape from a second vehicle. In that case, the processor may be configured to select an alternate sequence of actions in which the associated selection criteria are consistent with the additional traffic. In addition, the system may be configured to alert the driver of the subject vehicle whenever a third vehicle enters a threat zone while the implementation is occurring. For example, a second vehicle may be in the left-front sector or the right-front sector of the subject vehicle, thereby triggering a deceleration maneuver, and then a third vehicle may then enter the left-back or right-back sector. The processor may then review the selection criteria and select a sequence of applying a gradual intervention calibrated to place the subject vehicle half-way between the second and third vehicles, so as to minimize the possibility of a collision with each of the vehicles. If the leading vehicle is traveling slightly faster than the following vehicle, then they will all drift farther apart and the hazard will self-resolve. However, if the leading vehicle is traveling slightly slower than the following vehicle, then the processor may be configured to wait until the faster vehicle pulls forward. If after a further waiting time the second and third vehicles are still in the side threat zones, the processor may be configured to begin an acceleration or deceleration maneuver depending on whether the front or back threat zones are clear. If none of those attempts is successful, the processor may then indicate a nonresolvable potential hazard, and the driver may elect to change lanes or do something else.

In some embodiments, the processor may determine when the traffic situation is such that the gradual intervention system is unable to resolve a potential hazard. For example, the processor may recognize a “boxed-in” condition wherein vehicles are present in both the front and back threat zones. Such a situation is unresolvable by gradual intervention steps which are limited to accelerations and decelerations only. An unresolvable situation may also be declared if an uncooperative driver remains in the blind spot after both acceleration and deceleration maneuvers have been attempted. Alternatively, the processor may be configured to determine that a situation is unresolvable when the processor has checked all of the previously-prepared sequences, and their variations, but found none that would resolve the potential hazard. The processor may then inform the subject vehicle driver that an unresolvable situation has arisen, so that the driver may respond using human intelligence to take the next step. After indicating to the driver that an unresolvable situation is present, the processor may then inhibit any further intervention, to avoid making matters worse. While the gradual intervention responses are inhibited, the processor may continue to monitor the second vehicle and may subsequently determine that the potential hazard has been resolved, for example by the driver taking action or by the second vehicle decelerating or by any other means. The processor may then lift the response inhibition and resume scanning for new potential hazards. Such an automatic recovery of the potential-hazard avoidance service, after an unresolvable situation has passed, would enable the system to detect and mitigate subsequent potential hazards.

In a further embodiment, the processor may be configured to terminate the gradual intervention if the subject driver performs any of a predetermined set of “contrary actions.” For example, a contrary action may comprise attempting to accelerate while the gradual intervention calls for deceleration, or vice-versa. A contrary action may comprise changing the accelerator pedal in the same direction as the intervention, but by an amount that corresponds to an acceleration or deceleration greater than that being applied by the gradual intervention; or pressing the brake pedal by any amount; or turning the steering wheel by any amount greater than a predetermined threshold, such as ±5 degrees, or turning on the turn signal. In addition, the potential-hazard mitigation system may have an on-off control such as a button within easy reach of the driver, who could force a termination at any time by tapping the button.

In another embodiment, the processor may be configured to continue the gradual intervention despite such contrary actions (other than the off-button, of course), and to linearly add the driver's actions to the intervention actions. Thus, if the intervention calls for an acceleration of 1 kph/sec and the driver presses the accelerator pedal by an amount that corresponds to an acceleration of 2 kph/sec, the subject vehicle would simply accelerate by the total, or 3 kph/sec. As a further option, the system may be configured to perform the larger of the driver's action and the sequence action, or the smaller of the two, or the average of the two.

In some embodiments, the processor may be configured to recognize when the subject vehicle is in a traffic jam, comprising dense slow-moving traffic with other vehicles on all sides. In most traffic jams, it is not possible to avoid having numerous vehicles in the side hazard zones for extended times because all lanes are occupied and the flow is nearly stopped. The processor may be configured to suspend or inhibit the gradual interventions as long as the subject vehicle's velocity is below a threshold such as 20 kph and the external sensors indicate that multiple vehicles are present in front, behind, and in the adjacent lanes. However, the potential-hazard avoidance service may resume as soon as the traffic picks up speed and the distances between the vehicles rise to a predetermined level. In a preferable embodiment, the emergency intervention capability still remains vigilant and ready to immediately respond to any imminent collision hazards that may arise, even during a traffic jam when the gradual intervention system is inactive. For example, the emergency intervention system may sound an alarm and resist the driver forcefully if the driver attempted to change lanes into an occupied left or right-side sector, thereby preventing a side-encroachment collision initiated by the subject vehicle. Likewise, the system may forcefully avoid colliding with a leading second vehicle that suddenly stops in the front threat zone. Thus, the emergency response system can prevent the two most common low-speed accidents in heavy traffic.

In some embodiments, the processor may be configured to calculate a total potential hazard value based on the sum of the potential hazards of all the other vehicles around the subject vehicle, and to seek a sequence of actions that would lower that total potential hazard. In a traffic jam or at freeway speeds in dense traffic, the processor may continually update the sequence being implemented according to the changing traffic and may continually perform mild adjustments to the speed of the subject vehicle to minimize the total potential hazard, or to minimize the maximum potential hazard, or other criteria related to the potential hazards of the other vehicles. In this way the system can provide the best defensive driving practices in real-time in all conditions including sparse traffic and heavy, at low speeds or high.

In some embodiments, the processor may be configured to continually plan an “escape route” to avoid any unforeseen threats such as a sudden emergent collision threat. For example, the processor may gradually accelerate or decelerate to keep at least one of the threat zones open, or at least to keep a channel wide enough to allow the subject vehicle to dash there safely in an emergency. When an imminent collision is detected, the emergency response system can use the escape route to avoid a collision. Such an escape route may comprise, for example, an unoccupied front threat zone so that the subject vehicle can accelerate out of a side-encroachment attack, or it may be an unoccupied back threat zone so the subject vehicle can brake strongly if needed, or it may be an unoccupied left or right side sector so that the subject vehicle can change lanes in an emergency, with simultaneous acceleration or braking as needed to execute the maneuver. In most situations, if the traffic is not too heavy, occasional gradual motions are generally sufficient to maintain at least one escape route at all times. The potential-hazard avoidance system may thus prepare, but does not take advantage of, the escape route; only the emergency collision-avoidance system takes the escape route, and only when necessary to avoid a collision.

In some embodiments, the processor may monitor the proximate vehicles and their velocities in real-time and may continually model the traffic using a predictive kinetic model for example, thereby ascertaining that an escape route remains available for the subject vehicle. In an emergency, the processor can then immediately initiate a move through the prepared escape route without having to re-calculate trajectories, and thereby avoid a collision very quickly. This would save valuable milliseconds since the processor has already completed the traffic analysis and already knows what direction is the current best escape route. Preferably, the processor has also determined whether there is room to swerve left or right, or whether the brakes are capable of stopping the vehicle before impacting the leading vehicle, and so can react instantly.

In some embodiments, the processor may continually maintain and update a list of possible escape routes along with the desirability for each. The desirability of each optional escape route may depend on how much space is available fore, aft, left, and right of the subject vehicle, while avoiding zones that are currently occupied. If surrounding traffic is such that all feasible escape routes become closed, the processor may then invoke a gradual intervention to cause the subject vehicle to move forward or back relative to surrounding vehicles, so as to open an escape route. If this is not possible due to vehicles in the front and back threat zones, then the processor may alert the driver that the vehicle is in tight traffic with no current escape route.

In some embodiments, the hazard avoidance system may be configured to include a cruise-control system whereby the driver sets a desired speed and the system maintains that speed by adjusting the throttle or other speed control. Alternatively, the cruise-control may be separate from the hazard-avoidance system, but the two systems are in cooperative communication. In either case, implementing a gradual intervention may simply comprise adjusting the cruise-control speed setting slowly upward and downward according to the selected sequence of actions.

In some embodiments, the hazard avoidance system may be configured to include a lane-keeping assistance capability wherein the system detects lane markings relative to the current position of the subject vehicle and provides continuous small adjustments to the steering to remain centered in the lane.

In some embodiments, the hazard avoidance system may be configured to include, or to cooperate with, a frontal collision avoidance system which can apply the brakes, strongly if necessary, to avoid hitting the vehicle in front. For example, the hazard avoidance system may have a special response to a frontal collision threat, namely applying the brakes hard. Although this is not included in the gradual mitigation sequences, it may be necessary to avoid a common and dangerous highway collision.

In some embodiments, the subject vehicle may have an emergency collision-avoidance system in addition to the potential-hazard avoidance system. The collision-avoidance system may be able to apply the brakes or steering or acceleration to the maximum level that the vehicle is capable of, in order to avoid or minimize an imminent collision. The collision-avoidance system may automatically take over control from the hazard-avoidance system, to perform an emergency intervention without conflict. The imminent collision may be detected by the hazard-avoidance system which then may invoke the emergency response system, or the emergency intervention system may detect the emergency first. In either case, the potential-hazard avoidance system and the emergency collision-avoidance system may be configured to share information so that the emergency intervention system can respond quickly, using the data already analyzed by the potential-hazard avoidance system for example, and begin immediately implementing whatever strong collision-avoidance actions are necessary.

In some embodiments, the emergency collision-avoidance system and the hazard-avoidance system may comprise a single system with two modes, one mode for potential hazards only, and a second mode for imminent collision threats that require maximal acceleration, deceleration, braking, and/or steering. For example, the computer-readable media may contain two groups of sequences of actions, one group suitable for gradual mitigation of potential hazards, and a second group suitable for fast emergency intervention to avoid an imminent collision. The processor may then be configured to select a particular sequence of actions based on whether the situation is a potential hazard or an immediate emergency. The system may be configured to prevent the two modes, or the two intervention systems, from operating at cross purposes. The potential-hazard avoidance system may be configured to give control to the emergency intervention system whenever an emergency is invoked, and to terminate or suppress entirely any gradual intervention that may be active at that time.

In some embodiments, the hazard-avoidance system may include user-adjustable parameters. The user-adjustable parameters may comprise variable parameters such as the length of the initial delay time before an intervention is started. The parameters may include a second delay time during which an ongoing implementation is continued after detecting that the second vehicle has exited the threat zone, to ensure that the potential hazard has cleared. The parameters may include the amount of change in the accelerator pedal or steering wheel that would cause the processor to terminate an intervention. The parameters may include a maximum allowable magnitude of acceleration, jolt, or speed relative to the initial speed. The parameters may comprise discrete parameters such as how many times to attempt a mitigation before contacting the driver for help. The system may include adjustment means for adjusting the parameters, such as a knob or a voice-controlled application, or a touch-sensitive screen display that the user can input preferences using widgets for example. The system may restrict the times when the user can make changes to the parameters, for example allowing changes only while the vehicle is stationary and/or in parking gear. The system may further include parental controls that override any settings that a young driver may attempt to set.

In some embodiments, the system may include means for detecting and discouraging abusive reliance on the hazard-avoidance actions. Such abusive reliance may comprise deliberately approaching a lead vehicle in order to trigger a deceleration response, or otherwise initiating a hazardous maneuver that the system is configured to mitigate. The processor may be configured to illuminate a dashboard indicator or other indicator showing that the potential-hazard avoidance system is being used unsafely, or to restrict the subject vehicle in some way such as limiting the speed, or to record such abusive actions in a non-erasable memory for example.

In some embodiments, the system may include indicators that indicate various traffic conditions and/or responses of the potential-hazard avoidance system. The indicators may be visual such as a lamp, and/or flat-screen display, and/or acoustical such as a tone and/or computer-generated speech, and/or tactile such as a vibropad on the steering wheel and/or on the driver's seat back for example. Each indicator may indicate when a potential hazard has been detected, and/or whenever a sequence of actions is being implemented, and/or whenever a sequence of actions is terminated, and/or whenever a sequence exits normally, and/or whenever a sequence exits abnormally for example.

In some embodiments, the system may include recording means such as non-transient computer-writeable media and may be configured to record events leading up to and during a potential-hazard avoidance intervention. The media may be non-erasable. For example, the system may be configured to record data pertaining to each potential hazard detected and/or each gradual intervention performed. Such data may be useful for improving the standard sequences of actions and may also reveal aspects of the driver's behavior such as a tendency to tailgate upon other cars.

In some embodiments, the system may include a microphone and/or means for interpreting spoken commands. For example, the system may be configured to recognize specific commands such as commands to change a setting, or to terminate an ongoing implementation of a sequence of actions, or to stop all further potential-hazard avoidance activity, or to turn off the potential-hazard avoidance system altogether. The interpreted command response may include a confirmatory reply such as “Stop the system, are you sure?” before proceeding with the command execution. The system may include indicator means showing that the spoken command was indeed executed as the driver intended.

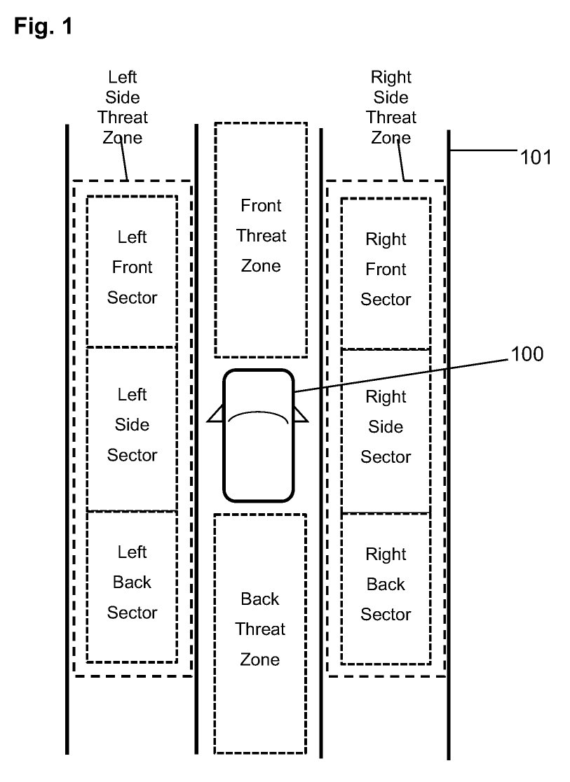

Turning now to the figures, FIG. 1 is a schematic showing an exemplary distribution of threat zones around a subject vehicle 100 between lane markings 101 on a multilane highway. In the embodiment depicted, the vehicle threat zones include a left side threat zone, a right-side threat zone, a front threat zone, and a back-threat zone (collectively, the “threat zone”). The side threat zones may include subdivisions or sectors having different threat properties. The left side threat zone may include a left back sector representing the left blind spot of the subject vehicle 100, and a right back sector representing the right blind spot of the subject vehicle 100. The left front sector and right front sector may comprise regions where a second vehicle driver would likely be unable to see the subject vehicle 100 due to the second vehicle's blind spots. Directly to the left of the subject vehicle 100 is the left side sector, comprising all the space between the left front and left back sectors, and likewise for the right-side sector. The left side threat zone may comprise the left front, left side, and left back sectors combined, and likewise for the right-side threat zone. A second vehicle located anywhere in the left or right threat zones may represent a potential hazard since a collision or near-collision could occur if either vehicle suddenly changed lanes. The front threat zone may comprise a region where a second vehicle, if it stopped suddenly, would likely cause a collision. The back-threat zone may comprise a region where, if it is occupied by a second vehicle, a collision would likely occur if the subject vehicle stopped suddenly.

In some embodiments, the sizes of the threat zones may be determined by the sizes of the vehicles, the sizes of their blind spots, and/or the amount of time needed for each driver to evade an encroaching vehicle at freeway speeds. Usually the size and location of a second vehicle's blind spots are unknown since they depend on the type and setting of the second vehicle's mirrors. The size and location of the subject vehicle's blind spots are also highly variable according to each driver's seat position, head height, mirror settings, and a host of other factors. Therefore, according to some embodiments, standard sizes may be assumed for the left and right front and back sectors. For example, each sector may be assumed to be equal in length to the subject vehicle, so that the left or right threat zones are each three car-lengths long. Thus, a vehicle changing lanes from anywhere in the left or right threat zones would either collide with the subject vehicle, or would cause a near-collision. As used herein, a near-collision occurs when two vehicles in the same lane are separated by one car-length or less, but not actually touching. Such a near-collision could become an actual collision if either driver makes the wrong move. Therefore, a second vehicle, or portion thereof, anywhere in the left or right threat zones around a subject vehicle represents a potential hazard.

In some embodiments, the front threat zone may extend from the front of the subject vehicle frontward to a distance at which a following driver could be expected to stop safely. That distance depends on the speed of the vehicles and many other factors. The “3-second rule” specifies that a safe intra-vehicle separation equals the distance they travel in 3 seconds, which at 100 kph is about 83 meters. Alternatively, the “one carlength per 10 mph” rule corresponds to about 22 meters at the same speed for vehicles with a 3.5 meter carlength. Thus, the 3-second rule is more conservative.

In some embodiments, the back-threat zone may extend from the back of the subject vehicle rearward for a distance, which may be the same distance as the front threat zone or a different distance. The sizes of the front and back threat zones may be adjusted according to the speed of the subject vehicle. The sizes of the left and right threat zones may be determined by the length of the subject vehicle regardless of speed, or they may be adjusted for speed and road conditions.

The system may apply different hazard-reduction steps depending on which region and which sector the second vehicle is in. For example, if the second vehicle is in the left front sector or the right front sector, the second vehicle represents a potential hazard because the driver may not realize that the subject vehicle 100 is in the second vehicle's blind spot and may suddenly change lanes, thereby colliding or nearly colliding with the subject vehicle 100. The system may initiate a gradual intervention to reduce the potential hazard as soon as the second vehicle enters the threat zone, such as gradually reducing the speed of the subject vehicle 100, thereby causing the subject vehicle 100 to slowly fall back until the second vehicle is fully ahead of the left threat zone.

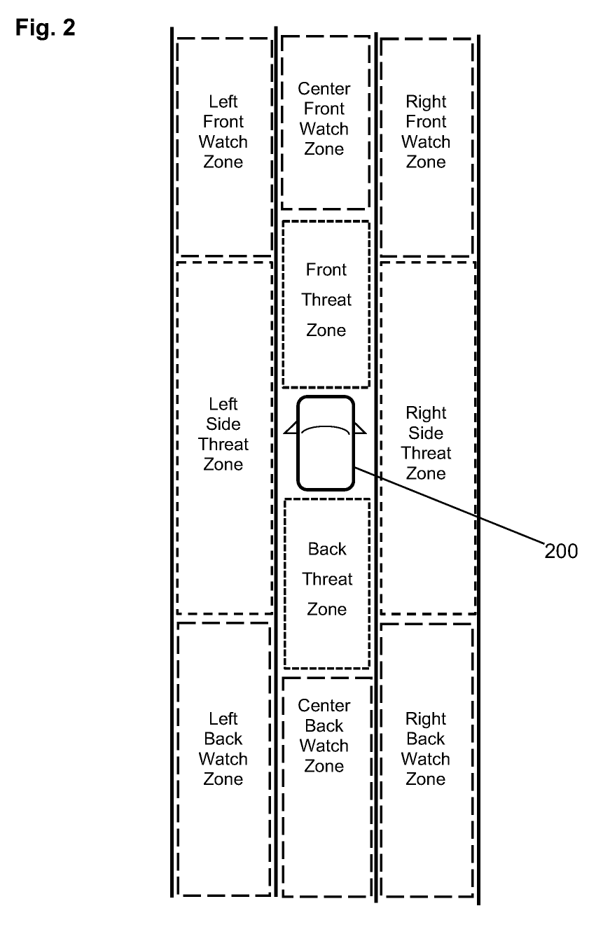

FIG. 2 is a schematic showing an exemplary distribution of threat zones and watch zones around the subject vehicle 200. The threat zones may be such as those described in FIG. 1, while the watch zones may extend farther frontward and rearward. Specifically, a left front watch zone may extend frontward from the left side threat zone for a distance, such as 20 vehicle lengths or the distance that the subject vehicle 200 travels in 10 seconds or other distance according to the implementation. Likewise, the right front watch zone may extend frontward from the right side threat zone, and the center front watch zone may extend frontward from the front threat zone. The left and right and center back watch zones may extend backward for a distance from the corresponding threat zones. Vehicles in the watch zones do not represent a potential hazard but may become a potential hazard as a result of actions by the subject vehicle 100 or other vehicles. For example, if a second vehicle enters the left side threat zone from the back and triggers a gradual acceleration response in the subject vehicle, this motion might result in a third vehicle being brought from the front right watch zone into the right-side threat zone. In general, the best sequence of actions may be selected by the processor taking into account the other traffic that may become a potential hazard. For the case of a third vehicle entering the threat zone, a better response may have been to decelerate and let the second vehicle pass, and thereby avoid approaching the third vehicle at all. By including the vehicles in the various watch zones when selecting a potential-hazard avoidance maneuver, the system may avoid such unintended consequences and may thereby provide improved avoidance of potential hazards.

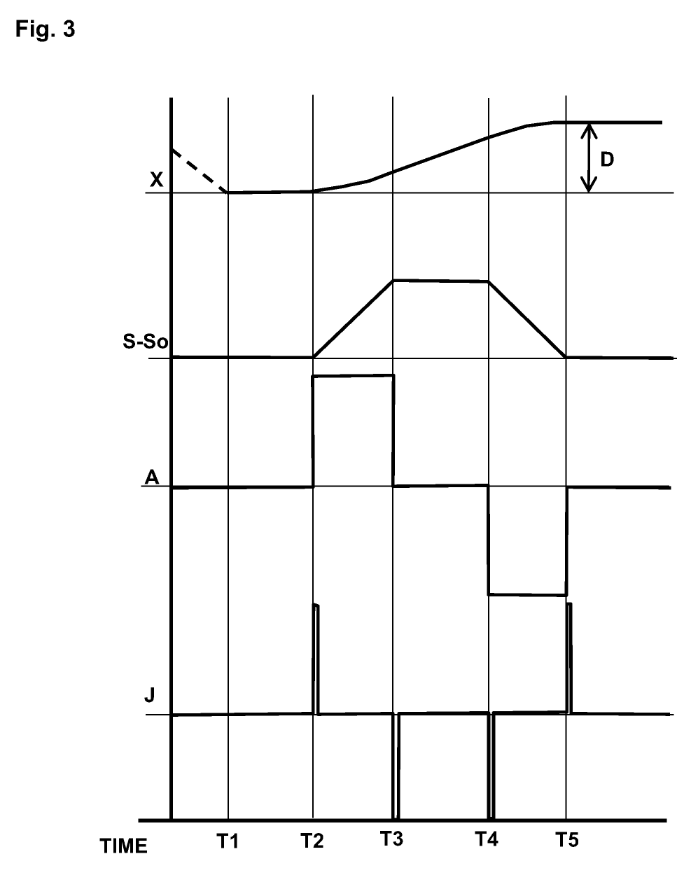

FIG. 3 is a series of graphs showing dynamical quantities related to an exemplary blind spot mitigation intervention, but not a gradual intervention. The dynamical quantities are: X, the distance between the second vehicle and the subject vehicle; S-So, the speed S of the subject vehicle relative to its initial speed (So) at the beginning of the intervention; A, the acceleration of the subject vehicle; and J, the rate of change of acceleration or jolt of the subject vehicle, all displayed versus time T. Initially, a second vehicle approaches the left or right threat zone of the subject vehicle, as indicated by a dashed line on the X plot, and at time T1 the second vehicle has entered the threat zone and remains there. An exemplary potential-hazard avoidance system on the subject vehicle detects the intrusion and starts a delay time clock.

At time T2, the initial delay time has expired and the potential-hazard avoidance system initiates an intervention designed to accelerate the subject vehicle until the second vehicle is no longer in the threat zone. In this example, the subject vehicle accelerates forward. In other cases, the subject vehicle may negatively accelerate (or decelerate), depending on traffic conditions and other conditions. The resulting acceleration is applied as indicated in the A plot, beginning at time T2 and extending to time T3. The incremental speed S-So accordingly increases linearly since the acceleration is roughly constant until the velocity has reached a target value or limiting value. Then, between times T3 and T4, the subject vehicle continues traveling with the constant enhanced velocity while the distance X between the vehicles increases. During the time interval T4-T5 the speed is again returned to the initial value by applying a negative acceleration (or deceleration) which is equal in magnitude but opposite in sign to the acceleration applied earlier. This brings the speed back to its initial value. As a result of the temporarily increased speed, the distance between the vehicles has increased to a safe distance D.

Although the potential-hazard avoidance system has successfully resolved the potential hazard, the intervention was carried out in a way likely to cause some distress to the subject vehicle driver. At each change of acceleration, a strong momentary jolt is produced, which may seem like a sudden loss of control to the subject vehicle driver.

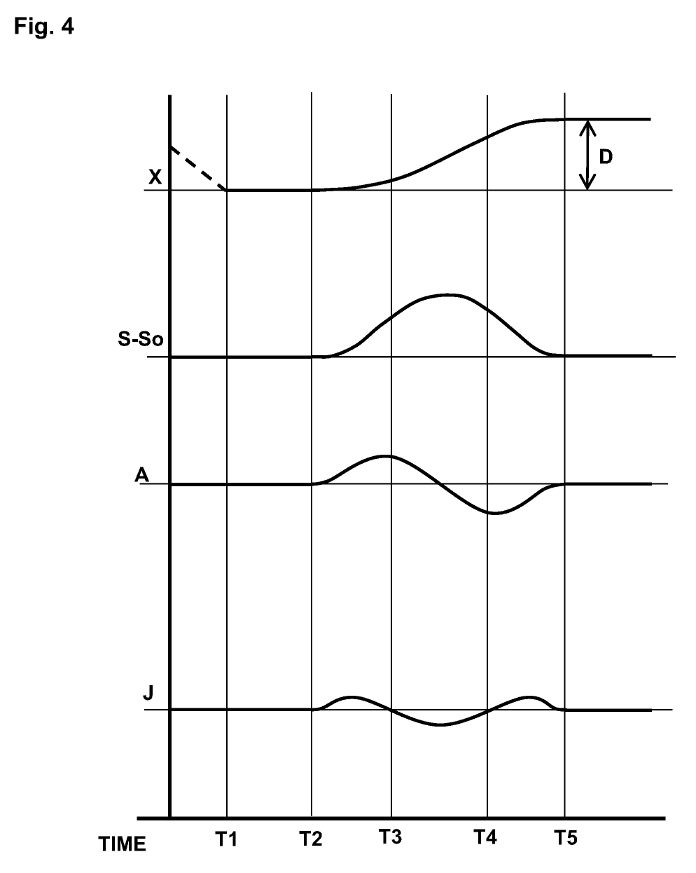

FIG. 4 shows a similar set of graphs for an exemplary automatic intervention, but now using a gradual intervention rather than an abrupt acceleration. In a gradual intervention, the acceleration may be configured to minimize the peak jolt. Accordingly, the acceleration may begin gradually at time T2, with very little peak jolt and an almost imperceptible speed change at first. The acceleration may be ramped up gradually between times T2 and T3, but smoothly so as to minimize the jolt and prevent driver discomfort. Preferably, the intervention is sufficiently gradual that the subject vehicle driver may not even notice that a gradual speed change was occurring, and if the driver did notice it, the change would be so gradual that the driver may not interpret it to be a loss of control but rather a normal speed variation, which is hardly distinguishable from those often occurring due to wind, terrain, etc. The driver may notice an indicator on the dashboard showing that a gradual intervention has commenced, and likely would allow the maneuver to proceed as usual, since the outcome is increased safety.

During the time interval T3-T4, the speed gradually increases, the distance between vehicles gradually opens up, and the acceleration is gradually ramped down to a deceleration value at T4 which is equal in magnitude to the positive acceleration at T3. Accordingly, the speed begins to gradually reduce. Then at T4-T5 the distance reaches the safe value D, the speed is gradually reduced to the initial value, the acceleration is gradually returned to zero, and the gradual intervention is complete. The jolt undergoes three slow transitions according to the derivative of the acceleration, but never exceeds a low value. The acceleration is initiated and terminated sufficiently gradually (at T2 and T5) to be barely noticeable. The jolt itself is also configured to start and stop gradually rather than suddenly, for even greater comfort of the driver and occupants of the subject vehicle. Mathematically, the jolt is the first derivative of the acceleration. As shown in the figure, the rate of change of the jolt, which is the second derivative of the acceleration, is zero at T2 and T5, thereby ensuring a smooth, nearly imperceptible intervention.

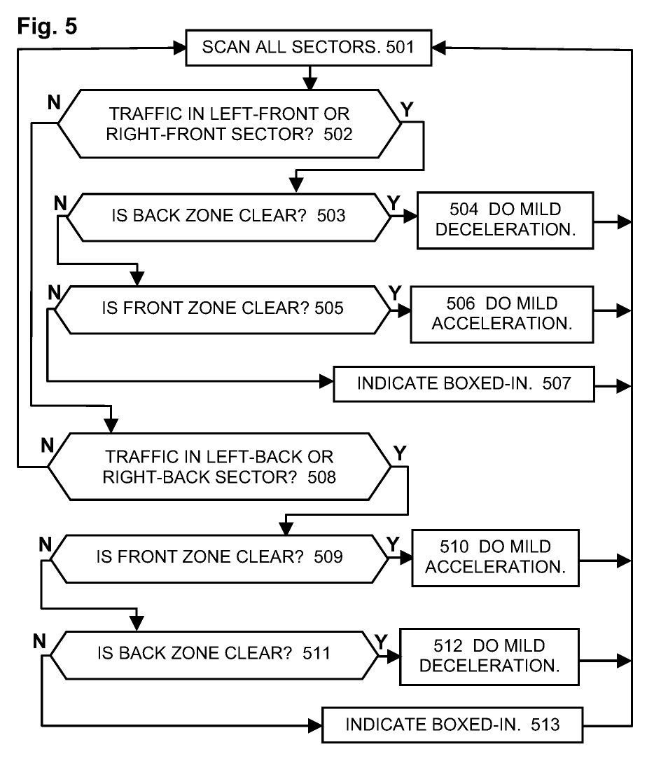

FIG. 5 is a flowchart showing steps of an exemplary potential-hazard avoidance method according to the present disclosure. The method resolves intrusions into the blind spot hazard regions only. Further methods of a similar nature may resolve side-encroachment, front zone, and back zone potential-hazard situations.

Initially 501 the potential-hazard avoidance system may scan all zones and sectors around a subject vehicle to detect all other vehicles proximate to the subject vehicle, according to some embodiments. For example, the scan may comprise analyzing data from cameras, radar, lidar, infrared, or other external sensors mounted on the subject vehicle. The sensors may be configured to cover the surrounding area with no blind spots, and thus are able to detect vehicles around the subject vehicle that the subject driver might miss.

Based on the scan results, the processor may determine 502 whether a second vehicle is in the left-front or right-front sectors. A vehicle in either of those sectors represents a potential hazard because the subject vehicle is likely in the blind spot of the second vehicle, which could at any time change lanes unsafely.

If there is a second vehicle in either of the left-front or right-front sectors, the processor may then check whether the back-threat zone and/or the back-watch zone is clear 503, and thereby determine whether conditions are safe to decelerate. If the back-threat zone and back watch zone are clear, the processor may perform a gradual deceleration 504, preferably according to the gradual procedure of FIG. 4. But if either the back-threat zone or back watch zone is not clear, the processor may then determine 505 whether the front is clear. If so, then the processor may proceed to carry out a gradual acceleration to draw past the second vehicle. Advantageously, the gradual acceleration may also draw the subject vehicle farther from the traffic that was detected in the back.

If both the front and back threat zones are occupied, the processor may then indicate 507 to the subject vehicle driver that the vehicle is in a boxed-in situation, with traffic too close both front and back, plus at least one potential blind spot vehicle. The driver can then decide what to do, such as changing lanes if space is open, or doing nothing, or at least remaining vigilant due to the tightening traffic.

Returning to step 502, the processor may determine that there are no vehicles in the left-front or right-front sectors. The processor may then check the left-back and right-back sectors 508. If those sectors are clear, the processor may return to scanning mode at 501. But if a vehicle is in the left-back or right-back sectors, which are likely in the subject driver's blind spots, the processor may respond by checking whether the front threat zone is clear 509, and if so, it may perform a gradual acceleration 510 to pull out of the potential hazard. If the front threat zone or front watch zone is occupied, the processor may check whether the back-threat zone is clear 511, and if so, it may perform a gradual deceleration instead 512. But if both front and back threat zones are occupied, then the system may again indicate to the driver that there is a problem. After each intervention or indicated action, the flow may return to the scanning mode as before.

As an option, the processor may be configured to avoid potential side-encroachment hazards by checking for a second vehicle in the left-side sector or the right-side sector. If either side threat zone is occupied, the processor may then check the front or back zones, and if either one is open, the processor can initiate a gradual acceleration or deceleration as appropriate. The side sectors represent potential hazards because a second vehicle positioned there could suddenly change lanes, due to inattention or an obstruction in the lane or a tire blowout or many other possibilities. The processor may be configured to avoid all such potential hazards by applying a gradual intervention to draw the subject vehicle away from any detected traffic in either of the side threat zones, so long as either the front or back zone is clear.

As a further option (not shown), the processor may respond to traffic in the front or back threat zones. If a vehicle is in the front threat zone, and the back-threat zone is clear, then the processor can initiate a gradual deceleration to open more space between the vehicles. Likewise, if the back-threat zone is occupied but the front threat zone is clear, then it can initiate a gradual acceleration for the same purpose. And if both front and back threat zones are occupied, then it can indicate a boxed-in situation to the driver.

In some embodiments, the processor may be configured to plan or calculate the gradual intervention before the action is initiated. The processor may be configured to take into account the road conditions and/or the apparent size of the second vehicle for example. If the second vehicle is a bus, the duration of the intervention and/or the maximum speed change may be adjusted larger than if the second vehicle is a regular car. And if the second vehicle is a tractor-trailer pulling a second trailer plus a yacht, an even longer or stronger intervention may be necessary to completely draw the subject vehicle out of the potential hazard. In each case, the intervention may be implemented in a sufficiently gradual fashion that the subject vehicle driver and other occupants perceive no change.

An intent of the disclosed potential-hazard avoidance system is to eliminate the most common traffic hazards by avoiding the potential hazards that lead to collisions. In some situations, however, the subject vehicle driver may wish to abort the gradual intervention. For example, if the driver decides to reject the intervention which is already in progress, then the processor may be configured to immediately stop accelerating or decelerating. In that case the processor may be configured to illuminate an indicator such as a dashboard light informing the driver that the potential-hazard avoidance system is suspended. In some embodiments, the driver can cause the potential-hazard avoidance system to abort by taking an action contrary to the intervention, or other action that would indicate a similar intent. For example, during a gradual intervention involving a deceleration, the driver may elect not to decelerate, and may press the accelerator pedal. This action thereby defeats the planned gradual deceleration and causes the processor to cease attempting the entire planned gradual intervention. The contrary action may also inhibit all further potential-hazard mitigations until being reset by the driver. Preferably, a slight variation in the accelerator pedal is not sufficient to abort the intervention, but a significant force on the accelerator pedal beyond a predetermined limit, such as a press corresponding to an acceleration of at least 2 kph/sec for example, is sufficient to abort the intervention. Tapping the brake pedal, or momentarily turning on the turn signal, or hitting a button or other control on the steering wheel or dashboard, can also accomplish the intervention termination.

In another embodiment, the potential-hazard avoidance system may act in a similar way to a conventional cruise-control system. For example, if the driver steps on the accelerator pedal during an automatic deceleration, the vehicle may comply with the driver's action which simply overrides the gradual intervention. This is just like a regular cruise-control which allows the driver to exceed the set speed at will. Then, after the driver releases the accelerator pedal, the system may return to the original planned speed, again like a cruise-control. On the other hand, if the driver taps the brakes, the gradual intervention may be configured to entirely disengage, again in the same way as a cruise-control works. The driver may restart the system by, for example, a button press. In an alternative embodiment, the contrary action may cause the current intervention to be terminated, but the system may not be inhibited thereafter, so that any future hazard would be handled automatically in the usual fashion. In that case the driver would not have to press a button or take other action to restore the potential-hazard avoidance service, since it would re-start automatically after the current potential hazard has been resolved.

Optionally, the system may monitor whether the gradual intervention was successful by determining whether the potential hazard was removed after a particular time interval, or after the gradual intervention is complete, or at other times such as periodically throughout the intervention. For example, a gradual acceleration may be initiated in response to a second vehicle entering the left-back or right-back sectors, and the gradual intervention may comprise moving the subject vehicle sufficiently ahead that the second vehicle should no longer be in the threat zone at time T5 of FIG. 4. Then, or at T5, the system can determine whether the second vehicle is still in the threat zone, which would indicate that the second vehicle has speeded up and has defeated the attempted hazard-avoidance maneuver. In that case, the system may repeat the maneuver but with a higher velocity or with deceleration instead of acceleration. If such a second attempt fails, then the system may inform the driver that there is a persistent problem.

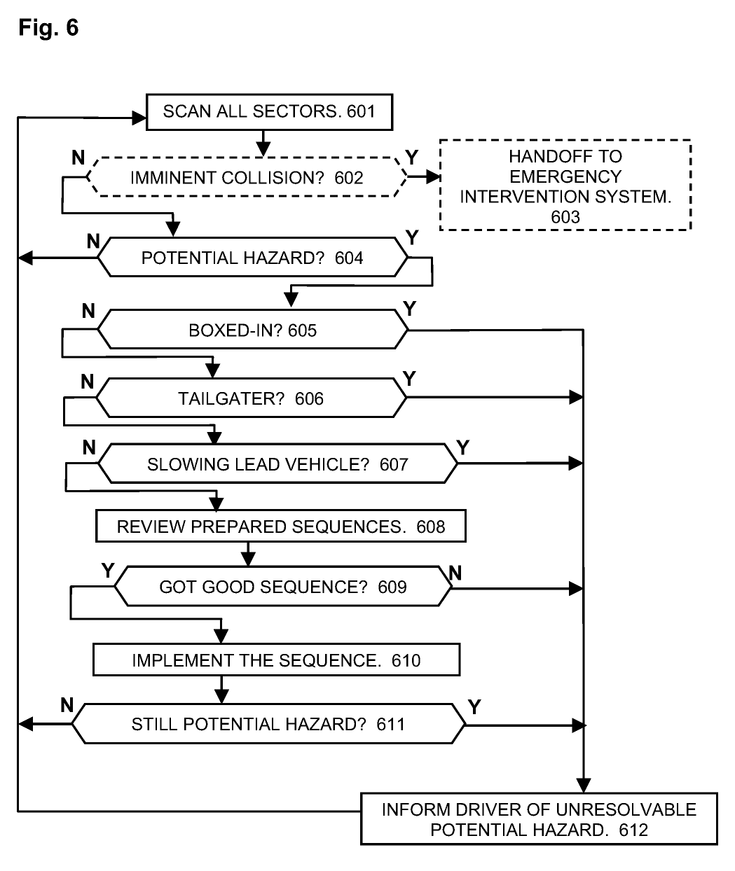

FIG. 6 is a flowchart showing steps of an exemplary method for determining whether a potential hazard can be resolved using gradual acceleration and deceleration. It is important for any automatic intervention system to recognize situations that it cannot handle, and to call for human backup. Accordingly, if the potential hazard cannot be resolved by gradual interventions, the potential hazard is deemed unresolvable, and the system may then inform the driver of that fact so that the driver can use human intelligence to decide what to do. Also, if the system detects an imminent collision or other emergency, and if the vehicle is equipped with an emergency collision-avoidance system, the potential-hazard avoidance system may immediately activate the emergency intervention system and may also pass data to it on the traffic situation as determined by the potential-hazard avoidance system. The potential-hazard avoidance system may be configured to withhold all gradual interventions so as not to interfere with the emergency intervention system.

First 601 the traffic in all sectors around the subject vehicle may be scanned using the external sensors. Optionally (in dash) the system may determine 602 whether an emergency condition is present, such as an imminent collision. If an emergency condition is present, the potential-hazard avoidance system may be configured to hand control to the emergency intervention system 603. If there is no imminent collision or other emergency, the flow may proceed directly to a determination of any potential hazards 604 around the subject vehicle. If no potential hazards are detected, then the flow may be returned to the beginning 601 to continue scanning traffic.

If a potential hazard is detected 604, the system may check a series of category questions. The system may determine whether the subject vehicle is boxed-in 605, that is, with a vehicle in front and another vehicle behind the subject vehicle such that the subject vehicle cannot accelerate or decelerate safely. If so, the system may inform the driver 612 of the boxed-in condition, which the potential-hazard avoidance system has no way to escape from. But if the subject vehicle is not in a boxed-in condition, the system may then check if the subject vehicle is being approached by a tailgater 606. A gradual acceleration may not be sufficient in such a case, and so the system may alert the driver. Then the system may check whether the potential hazard is a lead vehicle which is actively slowing down 607. Additionally, the system may check if the lead vehicle's brake lights are illuminated (not shown). Again, a gradual deceleration may not be sufficient, and so an unresolvable alert may be indicated (and optionally the processor may begin a deceleration anyway to provide additional response time).

If the potential hazard is not an imminent collision, nor a tailgater, nor a slowing lead vehicle, then the situation is nominally resolvable and the potential-hazard avoidance system may be able to handle it. The potential-hazard avoidance system can then review 608 a series of previously-prepared and stored sequences of actions, preferably selecting 609 only those sequences that are relevant to the potential hazard at hand. If no appropriate sequence is available, the system can alert the driver that the current hazard is indeed unresolvable and may be configured to then take no action. But if an appropriate response to the potential hazard is found, the selected sequence may then be implemented at 610. Then 611, after the gradual intervention sequence has been completed, the system can determine whether the potential hazard condition has been cleared. Alternatively, the system can wait an additional brief time to ensure that the second vehicle has sufficient time to exit the threat zone. Then, if the potential hazard is still present, this would indicate that the other vehicle driver is uncooperative, or that the traffic is rapidly thickening, or some other condition requiring the driver's attention. And, if the potential hazard has been successfully resolved by the gradual intervention sequence, then flowchart returns to 601 for continued traffic monitoring.

Optionally (not shown) the system can invoke a gradual acceleration responsive to a tailgater at 606, or a gradual deceleration responsive to a slow lead at 607. Although gradual mitigation may not satisfy an aggressive tailgater, at least it may open some space for a different solution. The system may be configured to avoid hazards when possible and to minimize them to the extent feasible when not avoidable.

Informing the driver of an unresolvable potential hazard 612 may comprise illuminating an indicator on the dashboard or elsewhere, optionally accompanied by an acoustical alert or other means for getting the driver's attention. Preferably, the informing means is not so distracting that it would become a potential hazard in itself. However, the indicator may include information specifying the type of hazard detected, such as computer-generated speech describing the problem.

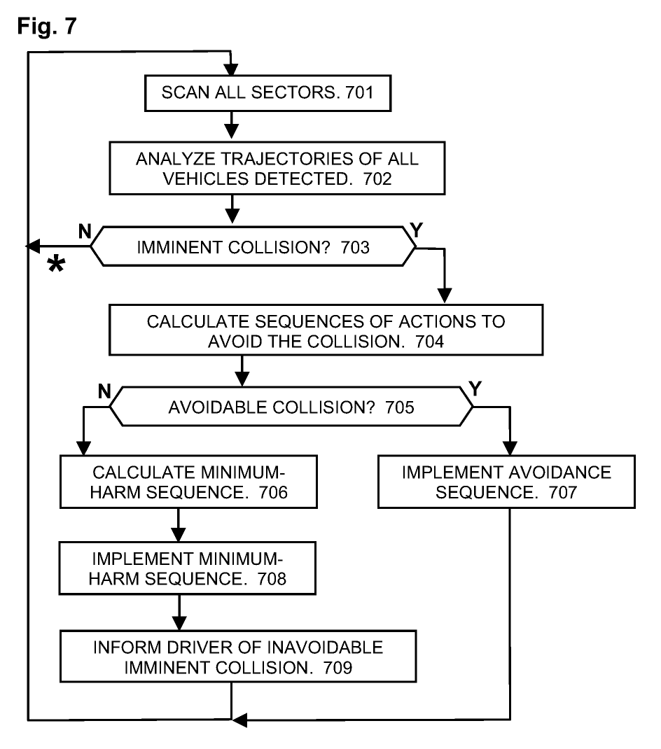

FIG. 7 shows a flowchart of an exemplary method to respond to emergency conditions such as an imminent collision, according to some embodiments. As with the potential-hazard avoidance system, the emergency intervention system can also determine when conditions are such that it needs human assistance. However, the emergency intervention system differs from the potential-hazard avoidance system in that the emergency system cannot simply abandon the driver in a life-threatening situation; it must continue trying to handle the emergency with the least harm possible, until the human driver can take over.

In the flowchart, the emergency intervention system scans for vehicles around the subject vehicle at step 701 and analyzes the trajectories of any detected vehicles at 702. The scanning and analysis steps may be performed independently in parallel by the potential-hazard and emergency intervention systems. Or, the steps may be performed by a central processor and the results may be shared with the two systems. Or, the emergency system can do the scanning and initial analysis and determine that a potential hazard exists but no real emergency and can then hand off to the potential-hazard avoidance system. Or, a single system can provide both potential-hazard and emergency interventions by selecting from a different group of sequences of actions depending on the type of hazard detected. While some of the examples provided herein specify two separate systems that provide potential-hazard avoidance and emergency intervention separately, in other embodiments there is only a single intervention system configured to generate gradual mitigations for potential hazards and extreme interventions for emergency situations.

Continuing with the flowchart, if the emergency intervention system determines 703 that there are no imminent collisions, the flowchart may return to the scanning step 701. But if the processor detects an imminent collision 703, it can immediately calculate 704 sequences of actions to avoid the collision. The sequences may include previously-prepared standard sequences that have been shown to be effective in similar threat situations and are stored on computer-readable non-transient memory. The processor can also prepare entirely new sequences which may be adapted to the evolving threat. In both cases (predetermined sequences and newly-created sequences), the values of parameters in the sequences may be varied and the future trajectories of the subject and second vehicles may be re-calculated according to each sequence and variation, thereby determining whether any of the sequences can avoid the collision 705. If so, one of the avoidance sequences is selected and implemented at 707. If none of the sequences would avoid the collision, the same sequences and/or additional sequences may then be reviewed to determine which would result in the least harm 706, preferably using a formula to estimate the collision harm in terms of number of fatalities, number of injuries, and property damage expected in the collision. Then the particular sequence that was calculated to produce the least harm may be implemented 708. The emergency intervention system may inform the driver that an emergency intervention is in progress, and/or that a collision is going to happen (including optionally the remaining time to collision), and/or that the system needs help from the human driver to avoid the collision. In some situations, the human driver may perceive a way to avoid the collision that the automatic system did not find. In other situations, there may simply be no time for the human driver to react.

In some embodiments, the system may be configured to activate a potential-hazard avoidance mode when no imminent collisions are detected. This option is indicated by an asterisk following step 703. The system can then determine whether a potential hazard exists, and then can determine whether the potential hazard can be resolved by gradual accelerations or decelerations and can then continue according to FIG. 6. Thus, the system of FIG. 7 may incorporate, or else branch to, the system of FIG. 6 whenever there is a potential hazard but no immediate threats.

In some embodiments, the human driver and the potential-hazard avoidance system and the emergency intervention system work together as partners, with the potential-hazard avoidance system handling non-emergency maneuvers gradually and transparently, and the emergency intervention system taking over when extreme actions are needed to mitigate a collision, and the human driver directing everything else.

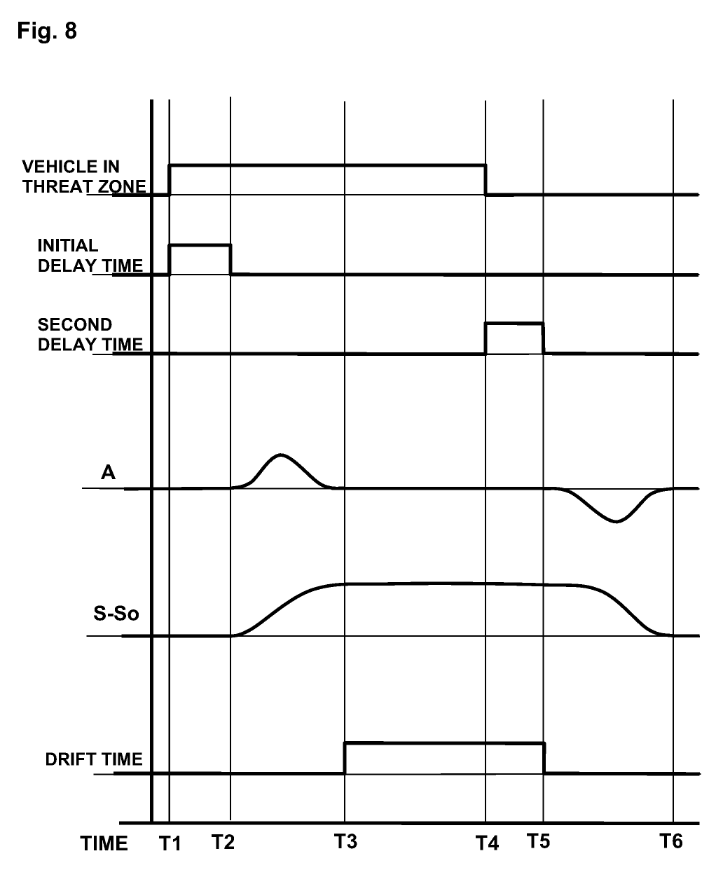

FIG. 8 is a series of graphs showing various dynamic parameters versus time during an exemplary potential-hazard intervention. At time T1, a second vehicle enters one of the side threat zones of the subject vehicle as indicated in the first graph, and at the same time a first delay time clock demarks a first interval as indicated in the line “Initial Delay Time”. The initial delay time clock expires at time T2, at which point the system again determines whether the second vehicle is still in the threat zone. In the depicted case, it is. Therefore, the system then begins implementing a selected sequence of actions involving a gradual increase in speed relative to the initial speed as shown in the graph S-So. To cause that change in speed, the acceleration A is applied between times T2 and T3, but the acceleration is increased very gradually and withdrawn very gradually so as not to produce a strong jolt. Accordingly, the speed increases very gradually during T2-T3 and remains substantially constant thereafter. Then at time T4 the second vehicle exits the threat zone, due to the subject vehicle having moved ahead sufficiently. Also, at T4 a second delay time clock is started, and expires at T5. The extra distance covered during the second delay time T4-T5 ensures that the second vehicle is well outside the threat zone. Applying such a second delay time before terminating the intervention thereby avoids prematurely terminating the intervention. Then at T5 a negative acceleration or deceleration is performed, very gradually to prevent a perceptible jolt. As a result, during T5-T6, the speed is restored back to the initial speed So. The areas under the positive acceleration curve and the negative acceleration curve are equal, which mathematically ensures that the final speed is equal to the initial speed. The last line of the figure shows the Drift Time, which is the time between the end of the positive acceleration at T3 and the start of the deceleration at T5. The Drift Time may be predetermined by the processor in preparing the sequence of actions, or the Drift Time may be variable such that the deceleration phase is delayed until after the second vehicle exits the threat zone and after the second delay time.

In some cases, the second vehicle may speed up during the intervention, thereby remaining in the threat zone. In that case the processor may determine, after keeping the speed constant for the predicted drift time, that the second vehicle driver is uncooperative. The processor may then terminate the intervention by returning the speed to the initial speed. If the second vehicle persists in its higher speed, this may allow the second vehicle to pass by. Alternatively, the processor may then implement a deceleration-type intervention to further dislodge the second vehicle. If that still doesn't work, the system may declare that the situation is unresolvable by the potential-hazard avoidance system and may ask the driver for help.

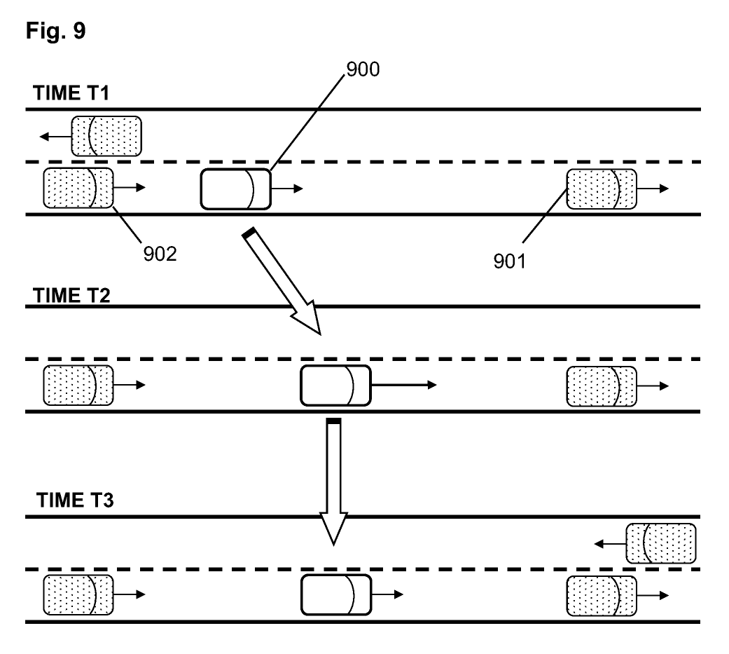

FIG. 9 is a schematic showing the distribution of traffic at three successive times while an exemplary gradual intervention is implemented. Here the subject vehicle 900 is shown as a clear icon while the other vehicles 901 and 902 are shown in stipple. The vehicles are on a two-lane road with traffic flowing in both directions as shown. At time T1, the subject vehicle 900 is between two other vehicles 901 and 902, which occupy the front and back threat zones respectively, and they are all traveling at the same speed as indicated by arrows attached to each car icon. Since the other vehicles 901 and 902 are in the front and back threat zones, the subject vehicle 900 is boxed-in. The processor may be configured to minimize the potential hazard by centering the subject vehicle 900 between the other two cars 901 and 902. Initially, the subject vehicle 900 is closer to the following vehicle 902 than to the leading vehicle 901, and therefore the subject vehicle 900 performs a sequence of actions comprising first accelerating until the subject vehicle 900 is midway between the other two cars 901 and 902, and then decelerating until the speed of the subject vehicle 900 matches that of the other two cars 901 and 902, or until the speed of the subject vehicle 900 is midway between the other cars' speeds. A hollow arrow shows how the subject vehicle 900 moves between time T1 and T2 to become centered, and then from time T2 to T3 the subject vehicle 900 adjusts its speed to match the other cars 901 and 902. Then, if the leading vehicle 901 is going slightly faster than the following vehicle 902, the cars will gradually draw apart, which will clear both the front and back threat zones eventually. But if the leading vehicle 901 is going slower than the following vehicle 902, then the three vehicles will gradually draw closer together, which increases the risks to all three drivers. In that case, the system may alert the subject vehicle driver to the worsening boxed-in situation.

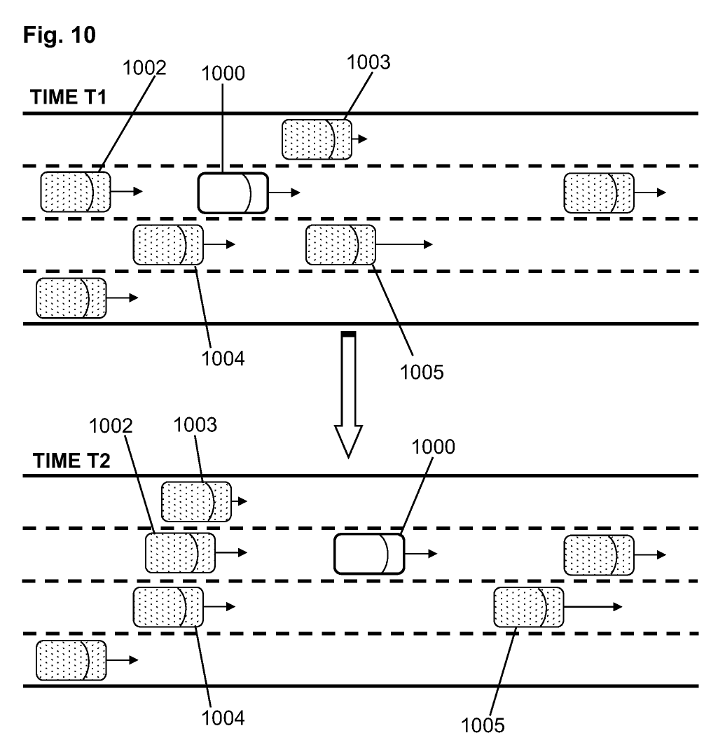

FIG. 10 is a schematic showing dense traffic and an exemplary resolution to multiple potential hazards. In ordinary freeway driving, it is common to have multiple other vehicles continually passing into and out of the threat zones, with several potential hazards being current at any given time. Due to the density of the traffic, it is not possible to maneuver so as to avoid all of these time-varying potential hazards. Therefore, in some embodiments, the system may be configured to calculate a total potential hazard that accounts for all of the other vehicles and their associated potential hazards quantitatively and may be configured to gradually adjust the speed of the subject vehicle to minimize the total potential hazard dynamically, or to minimize the greatest potential hazard, or other criterion for action. The system may be configured to continually monitor or model the evolving traffic situation and to provide minor speed adjustments in real-time to maintain as low a total potential hazard as possible.

For example, in some embodiments, the processor may be configured to calculate a potential hazard value for each of the other vehicles proximate to the subject vehicle, and to add those values to obtain the total potential hazard. The contribution from each of the other vehicles may depend on the spatial relationship between the subject vehicle and the other vehicle, as well as their relative speeds and other dynamical factors. As a non-limiting example, the processor may assign a potential hazard value of 10 points for each vehicle in a left side or right-side sector since a lane change attempt could result in an immediate crash, and 3 points for each vehicle in a front or back side sector since a lane change would cause only a dangerous near-miss. The processor may assign a value of 1 point for a tailgater in the back-center threat zone and 2 points for a slow lead vehicle in the front center threat zone for example. Alternatively, the processor may calculate the potential hazard values according to a formula such as 5/N points for a tailgater where N is the number of carlengths between them, and 10/N for a slow lead vehicle. At high speeds, the number of points for the tailgater and slow lead vehicle may be doubled in view of the shorter reaction time available at the higher speed. At low speeds or stopped traffic, as in a traffic jam, the point values may be further adjusted to reflect the different threats represented by vehicles in the various threat zones in a traffic jam.

In some embodiments, the processor may be configured to add the potential hazard values to obtain a total potential hazard value, and to cause the subject vehicle to move so as to minimize the total potential threat value. For example, the processor may be configured to prepare one or more sequences of actions, each action comprising a gradual acceleration or deceleration, and to calculate the change in the total potential hazard value if the subject vehicle were moved according to each of the sequences, and thereby determine which of the sequences would lower the total potential hazard most effectively. The most effective sequence may be selected as the one that reduces the total potential hazard most quickly, or the one that eventually brings the total potential hazard to the lowest value, or the one that minimizes the highest potential hazard value among the various other vehicles, or other criterion. The system may then implement that gradual mitigation, while continually recalculating the current total potential hazard value and the predicted effects of mitigation actions.

The scenario of FIG. 10 illustrates such an intervention. The subject vehicle 1000 is initially, at time T1, among traffic with several other vehicles in the threat zones, resulting in a relatively high total potential hazard value. The processor may be configured to analyze the positions and motions of the other vehicles to find a sequence of actions that would reduce the total potential hazard value. In the depicted situation, the subject vehicle 1000 is being tailgated by a second vehicle 1002, is in the blind spot of a third vehicle 1003 and has a fourth vehicle 1004 in its blind spot, as well as other vehicles such as 1005. The processor may be configured to analyze the positions of the other vehicles as well as their near-term motions based on their velocities relative to the subject vehicle 1000 as well as optionally their accelerations. In particular, the processor may note that the third vehicle 1003 is going slowly in the left lane as indicated by its shorter arrow and will soon draw even with the subject vehicle 1000 which will elevate its potential hazard value. The processor may also note that the fifth vehicle 1005, although in the right front threat zone, is going faster and will soon pull away from the subject vehicle.

The processor may then project the various motions forward in time and determine that the total potential hazard can be lowered by gradually accelerating, thereby escaping from the tailgater 1002 at least temporarily, and hastening the passage of the slow left lane vehicle 1003, and also drawing away from the other hazards, while the potential hazard of the fifth vehicle will self-resolve and open a clear space. The distribution at time T2 shows how the subject vehicle 1000 has moved after that maneuver, which clearly reduces the total potential hazard by keeping as much distance from the other vehicles as possible.

The motions of FIG. 10 illustrate an additional benefit, which is to create an escape route for the subject vehicle 1000. At T1 there is no clear escape route. Although the front threat zone is relatively clear, two vehicles 1003 and 1005 are in the front left and right-side threat zones, leaving no escape if one of them suddenly encroaches on the subject vehicle 1000. Also, a frontal escape route is the most difficult direction to accomplish because it relies on the subject vehicle 1000 being able to rapidly accelerate out of a threat situation. For most vehicles, steering and/or braking provides a much faster escape, assuming the lanes are clear in the side or back directions. At time T2, on the other hand, the subject vehicle 1000 has obtained possible escape routes in both side directions, a much safer way to drive.

Embodiments of the potential-hazard avoidance system and associated methods disclosed herein provide many advantages in regard to highway safety. (a) The system can recognize and resolve potential hazards such as blind spot, side-encroachment, parallel-driving, front collision, and rear collision hazards before they become emergency situations, thereby preventing many collisions before they become imminent. (b) The system can provide potential-hazard avoidance service transparently and automatically, without needlessly distracting the driver or disturbing the occupants of the subject vehicle with sudden accelerations or strong velocity changes. (c) The potential-hazard avoidance can be straightforward, comprising simple acceleration and deceleration maneuvers, without the use of braking or steering actions unless the situation suddenly becomes an emergency. (d) Most highway potential hazards can be resolved using a few predetermined sequences of actions, which can be selected by matching traffic conditions to a set of selection criteria, all of which can be preloaded on computer-readable media. (e) The system can recognize when a situation is unresolvable by gradual accelerations and decelerations and may then ask the driver for assistance. In most situations, the system can handle the intervention without assistance, thereby avoiding burdening the driver with unnecessary information or distractions. (f) The system can respond automatically to all of the most common highway potential hazards including blind spot, side-encroachment, and front-rear collisions, resolving each potential hazard with a specific prepared sequence of actions. (g) The system can return the subject vehicle speed to the same value after the intervention as it had before the intervention, and with zero acceleration, but with the subject vehicle displaced forward or backward relative to the second vehicle as needed to escape the potential hazard. (h) The system may be configured to always avoid making a hazard worse, for example by checking whether the front or back threat zones are clear before starting an acceleration or deceleration, and by handing off the control to an emergency intervention system whenever the situation calls for it. (i) Embodiments of the system may be configured to calculate a total potential hazard value, and to move the subject vehicle to minimize the total potential hazard. (j) Embodiments of the system may move to create escape routes comprising clear directions that the subject vehicle may go in to avoid a collision. (k) Embodiments of the system are low-cost, user-friendly, and applicable to any vehicle.

The most cost-effective collision-avoidance strategy is simply defensive driving. The present system provides automatic and transparent defensive driving by continuously avoiding potential hazards. Cars rarely collide with each other if they are sufficiently widely spaced. When installed on cars and trucks in the coming years, the potential-hazard avoidance system will prevent most of the common highway hazards that lead to collisions, saving many lives.

It is to be understood that the foregoing description is not a definition of the invention but is a description of one or more preferred exemplary embodiments of the invention. The invention is not limited to the particular embodiments(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater, or different steps than that shown here. All such other embodiments, changes, and modifications are intended to come within the scope of the appended claims.

As used in this specification and claims, the terms “for example”, “e.g.”, “for instance”, “such as”, and “like” and the terms “comprising”, “having”, “including”, and their other verb forms, when used in conjunction with a listing of one or more components or other items, are each to be construed as open-ended, meaning that the listing is not to be considered as excluding other additional components or items. Other terms are to be construed using their broadest reasonable meaning unless they are used in a context that requires a different interpretation.

1. A system, comprising:
a subject vehicle, one or more sensors, a processor, and
non-transient computer-readable media containing a plurality of predetermined sequences of actions, each sequence comprising sequential periods of acceleration or deceleration or waiting, wherein each sequence of actions includes at least one period of acceleration and at least one period of deceleration, and wherein:
the one or more sensors are configured to collect data on one or more other vehicles proximate to the subject vehicle;
the processor is configured to determine whether one or more of the other vehicles is in a predetermined threat zone proximate to the subject vehicle;
the processor is further configured to select a particular sequence, of the plurality of predetermined sequences of actions, the particular sequence selected to move the subject vehicle relative to the one or more other vehicles in the threat zone;
the processor is further configured to send control signals to a speed controller according to the selected sequence of actions, and wherein the speed controller is configured to adjust a speed of the subject vehicle according to the received control signals, and thereby cause the subject vehicle to move relative to the one or more other vehicles which are in the threat zone; and
the processor is further configured to determine, after the subject vehicle has executed the selected sequence of actons, whether the one or more other vehicles are still in the threat zone.

2. The system of claim 1, wherein each sequence of actions is configured to limit the magnitude of the change in speed of the subject vehicle to no more than a predetermined maximum value or to no more than a predetermined fraction of the initial speed, or such that a jolt of the subject vehicle is limited to no more than a predetermined maximum value, or such that the magnitude of the acceleration of the subject vehicle is limited to no more than a predetermined maximum value.

3. The system of claim 1, wherein the system is configured to wait, after detecting a second vehicle in a threat zone, for a predetermined initial delay time, and then, responsive to the second vehicle remaining in the threat zone after the initial delay time to determine how long the second vehicle is expected to remain in the threat zone, and then, if the second vehicle is expected to remain in the threat zone for a time longer than a predetermined time limit, to begin implementing the selected sequence of actions.

4. The system of claim 3, wherein the method further includes:
while the second vehicle is in the threat zone, periodically measuring the speed of the second vehicle relative to the subject vehicle;
periodically calculating a dwell time based at least in part on the measured speed of the second vehicle; and
implementing the selected sequence of actions if the calculated dwell time is greater than a predetermined time limit.

5. The system of claim 1, wherein the method includes:
calculating a first exit time comprising a time interval at which the second vehicle is calculated to exit the threat zone;
if the first exit time exceeds a predetermined time limit, selecting a sequence of actions calculated to move the subject vehicle relative to the second vehicle until the second vehicle is no longer in the threat zone;
calculating a second exit time comprising a time when the second vehicle is calculated to exit the threat zone according to the sequence of actions; and
if the second exit time is less than the predetermined time limit, implementing the sequence of actions.

6. The system of claim 1, wherein the system is configured to terminate the implementation of the sequence of actions when the second vehicle exits the threat zone.

7. The system of claim 1, wherein the threat zone includes a left side threat zone and a right side threat zone in lanes adjacent to the subject vehicle lane respectively, wherein the left and right side threat zones extend from a first predetermined distance ahead of the subject vehicle to a second predetermined distance behind the subject vehicle.

8. The system of claim 1, wherein:
the threat zone includes a front threat zone and a back threat zone in the same lane as the subject vehicle;
the front threat zone extends for a first predetermined distance ahead of the subject vehicle and the back threat zone extends for a second predetermined distance behind the subject vehicle.

9. The system of claim 1, wherein the processor is configured to provide an alert to the subject vehicle driver when all of the sequences of actions are projected to fail to resolve the potential hazard.

10. The system of claim 1, wherein the method further includes:
reading, from the non-transient computer-readable media, a plurality of predetermined sequences of actions and a plurality of sets of selection criteria, each set of selection criteria being associated with one of the predetermined sequences of actions, respectively;
determining whether each set of selection criteria is consistent with the potential hazard;
when a particular set of selection criteria is consistent with the potential hazard, implementing the respective particular sequence of actions; and
when none of the sets of selection criteria is consistent with the potential hazard, alerting the subject vehicle driver that the potential hazard is unresolvable.

11. The system of claim 1, wherein the system is configured to inhibit the implementation of the sequence of actions when a potential hazard has become an emergency, and wherein the system is configured to determine that a potential hazard has become an emergency when either:
the subject vehicle has a left turn signal initiated while any vehicle is in a left side threat zone; or
the subject vehicle comes within a predetermined distance of a left lane marker and is moving to the left while a second vehicle is in a left side threat zone; or
the subject vehicle has a right turn signal initiated while a second vehicle is in a right side threat zone; or
the subject vehicle comes within a predetermined distance of the right lane marker and is moving to the right while a second vehicle is in a right side threat zone; or
the subject vehicle tires encounter a physical lane identifier adjacent to the second vehicle lane.

12. The system of claim 1, wherein the system is configured to inhibit the implementation of the sequence of actions when a potential hazard has become an emergency, and wherein the system is configured to determine that a potential hazard has become an emergency when either:
a second vehicle in a front threat zone is traveling at a speed at least a predetermined speed slower than the subject vehicle; or
a second vehicle in a back threat zone is traveling at a speed at least a predetermined speed faster than the subject vehicle.

13. The system of claim 1, wherein:
the system includes a potential-hazard mode and an emergency-response mode;
the potential-hazard mode prohibits braking and steering, and allows accelerations and decelerations only within limits; and
the emergency-response mode allows all actions within the capabilities of the subject vehicle.

14. The system of claim 1, wherein:
the non-transitory computer readable media contain gradual sequences of actions and emergency sequences of actions;
wherein the gradual sequences of actions comprise accelerations and decelerations within predetermined maximum limits, and do not include braking nor steering;
wherein the emergency sequences of actions comprise accelerations, decelerations, braking, and steering;
wherein responsive to a potential hazard, the processor is configured to select the particular sequence of actions from the gradual sequences of actions; and
responsive to an imminent collision, the processor is configured to select the particular sequence of actions from the emergency sequences of actions.

15. The system of claim 1, wherein the system is configured to terminate the implementing when the subject vehicle driver performs an action in the list of:
pressing a brake pedal;
turning a steering wheel by more than a predetermined angle;
changing pressure on an accelerator pedal by more than a predetermined amount;
turning on a turn signal;
turning off a cruise-control; or
turning off the system,
or when
the system determines that the current situation is unresolvable;
the system determines that all of the predetermined sequences of actions would fail to resolve the potential hazard;
the system determines that a collision is imminent;
the system detects an emergency situation; or
an emergency response system on the subject vehicle detects an emergency situation.

16. The system of claim 1, wherein the method includes:
determining, while a particular sequence of actions is being implemented, that a third vehicle has entered one of the threat zones;
selecting an alternate sequence of actions according to selection criteria associated with the alternate sequence of actions; and
implementing the alternate sequence of actions instead of the particular sequence of actions.

17. The system of claim 1, wherein the method further includes:
detecting a second vehicle positioned frontward of the subject vehicle in a side threat zone, and responsively decelerating the subject vehicle while a back watch zone is clear; and
detecting a second vehicle positioned rearward of the subject vehicle in a side threat zone, and responsively accelerating the subject vehicle while a front watch zone is clear.

18. The system of claim 1, wherein the method further includes:
detecting a second vehicle in a side threat zone;
detecting that the subject vehicle is within a predetermined distance of the lane occupied by the second vehicle and is moving toward the lane occupied by the second vehicle; and
responsively causing the subject vehicle to brake or to steer opposite to the lane occupied by the second vehicle, thereby causing the subject vehicle to veer away from the second vehicle.

19. The system of claim 1, wherein the system further includes a user-adjustable control that adjusts a parameter in the list of:
a first delay time during which the implementation of the sequence of actions is inhibited;
a second delay time during which an implementation is extended after the second vehicle has exited a threat zone;
a maximum acceleration;
a maximum jolt;
a maximum velocity change;
an amount of variation of the accelerator pedal that would cause the implementation to be terminated; and
an amount of variation of the steering wheel that would cause the implementation to be terminated.

20. The system of claim 1, wherein the system is configured to linearly add the actions of the selected sequence of actions to any actions of the subject vehicle driver, and to implement the resulting sum of the linearly added actions.

21. The system of claim 1, wherein the system further includes a visible or audible or tactile indicator that is activated whenever a potential hazard is detected, or whenever a sequence of actions is being implemented, or whenever the second vehicle remains in the threat zone after a sequence of actions has been implemented.

22. The system of claim 1, wherein:
the system further includes a non-transient computer-writeable storage medium; and
the system is configured to record, in the storage medium, data pertaining to each potential hazard detected and/or each sequence of actions implemented.

23. The system of claim 1, wherein the method further includes periodically identifying at least one escape route comprising a region proximate and contiguous to the subject vehicle having no vehicles therein, and wherein the method further includes:
periodically analyzing traffic proximate to the subject vehicle, thereby identifying escape routes;
while at least one escape route exists, determining a most-preferred escape route, and displaying a direction corresponding to the most-preferred escape route;
when no escape route exists, indicating that no escape route exists.

24. The system of claim 1, wherein the method further includes:
determining that a second vehicle is in the front threat zone and a third vehicle is in the back threat zone;
then positioning the subject vehicle midway between the second and third vehicles; and
then adjusting the speed of the subject vehicle midway between the speeds of the second and third vehicles.

25. A system comprising sensors, a speed controller, and a processor configured to perform a method comprising:
detecting one or more threat vehicles comprising vehicles in a predetermined threat zone proximate to a subject vehicle;
calculating a potential hazard value for each threat vehicle according to the amount of hazard of each threat vehicle; and
calculating a total hazard comprising the sum of the potential hazard values of the threat vehicles.

26. The system of claim 25, wherein the processor is further configured to send control signals to the speed controller so as to minimize the total hazard.

27. The system of claim 26, wherein the processor is further configured to calculate a plurality of sequences of actions, each action comprising a period of acceleration or deceleration or waiting, and to select a particular one of the sequences that minimizes the total hazard.

28. The system of claim 27, wherein the selecting includes calculating future trajectories of the subject vehicle and the threat vehicles, calculating the potential hazard for each threat vehicle according to the future trajectories, and thereby determining a total hazard for each of the plurality of sequences.

29. The system of claim 25 wherein the calculating a potential hazard of a particular threat vehicle includes calculating a result of a predetermined formula based at least in part on the position of the particular threat vehicle relative to the subject vehicle.

30. The system of claim 1, wherein the processor is configured to initiate no action while the subject vehicle is accelerating or decelerating at greater than a predetermined limit.
